(19) United States
(12) Patent Application Publication
(10) Pub. No.: US 2015/0100665 A1
(43) Pub. Date: Apr. 9, 2015

(54) DIGITAL DISPLAY TERMINAL, CONTENTS SERVER, AND METHOD OF TRANSMITTING AND RECEIVING CONTENT

(71) Applicant: ELECTRONICS AND TELECOMMUNICATIONS RESEARCH INSTITUTE, Daejeon-city (KR)

(72) Inventors: Wook HYUN, Daejeon (KR); Miyoung HUH, Daejeon (KR); Sunghei KIM, Daejeon (KR); Shingak KANG, Daejeon (KR)

(21) Appl. No.: 14/504,381

(22) Filed: Oct. 1, 2014

(30) Foreign Application Priority Data
Oct. 7, 2013 (KR) 10-2013-0119273

(51) Int. Cl. H04L 29/08; G06Q 30/02; H04L 1/16

(52) U.S. Cl. CPC H04L 67/06; H04L 1/1628; G06Q 30/0277; H04L 67/104
USPC 709/217

(57) ABSTRACT

A digital display terminal, a contents server, and a method of transmitting and receiving content are disclosed. In the method, notification of a content distribution plan, including information about an ID of the specific content, overlay network ID information for the specific content, and an address of a tracker server function unit, is received from the contents server or another terminal within the overlay network. A list of terminals, included in the overlay network identified by the overlay network ID information, or a list of terminals, managed by the tracker server function unit identified by the address of the tracker server function unit, is received from the contents server or the other terminal. Held content information, indicating whether or not the specific content is held, is received from one or more of the terminals within the list, and the specific content is received from the one or more terminals.

### CROSS REFERENCE TO RELATED APPLICATION

This application claims the benefit of Korean Patent Application No. 10-2013-0119273, filed Oct. 7, 2013, which is hereby incorporated by reference in its entirety into this application.

### BACKGROUND OF THE INVENTION

1. Technical Field

The present invention relates generally to a digital display terminal, a content server, and a method of transmitting and receiving content and, more particularly, to a method and apparatus for distributing and receiving content between a digital signage server and terminals using a peer-to-peer (P2P) method in a digital signage environment.

2. Description of the Related Art

Digital signage is a communication tool that serves as a medium for the marketing, advertising, training effects and customer experiences of companies, and refers to a digital image device or system that is capable of providing specific information as well as broadcast programs in public places, such as airports, hotels and hospitals.

In other words, digital signage is outdoor advertising using digital information display (DID) technology, and also refers to an advertising board whose advertising content may be controlled by a control center by means of a communication network.

Such digital signage may provide existing commercial DID applications with a software or management platform which may control main functions.

In such a digital signage environment, in order to provide stable service, most digital signage servers to date have previously distributed content among all terminals.

The conventional distribution method has problems in terms of a load of a system and efficiency of distribution upon distributing a large amount of content having high picture quality among a large number of terminals. Furthermore, a server may experience a bottleneck if a large number of terminals update their content at the same time. Content may be alternatively distributed over a separate content delivery network (CDN), which incurs high expenses.

In particular, stability is required upon distributing content because specific content needs to be commonly played back at a specific time according to the characteristics of digital signage. The reason for this is that high speed is required when digital signage is used if digital signage is used for the execution of contracts with an advertising contractor, and for the provision of a disaster warning. Accordingly, stability needs to be taken into consideration in a content distribution method.

As a related art, U.S. Patent Application Publication No. 2011-0010732 entitled “System and Method for delivering and optimizing Media Programming in Public Spaces with Peer-to-peer Digital Signage Networks” discloses technology in which a digital signage network operates likes a P2P network in such a manner that, in the digital signage network, each computing device checks its storage and requests content to be displayed from at least one other computing device if the content to be displayed is not available upon completion of the check.

As another related art, Japanese Patent Application Publication No. 10-2008-304980 entitled “Data File Distribution System” discloses technology in which a server device includes a third server capable of distributing a single data file as small sub-divided files and the distribution management means of the server device directly distributes data files, obtained from the third server, into a client when the distribution of the data files into the client is expected to be delayed from a specific time.

As still another related art, U.S. Patent Application Publication No. 10-2009-0319625 entitled “Interactivity in Digital Public Signage Network Architecture” discloses technology in which the congestion at bottleneck points is mitigated by applying P2P content distribution to a digital signage network.

### SUMMARY OF THE INVENTION

Accordingly, the present invention has been made keeping in mind the above problems occurring in the conventional art, and an object of the present invention is to provide a method of efficiently distributing content in a digital signage environment and also to provide a digital display terminal, a contents server, and a method of transmitting and receiving content, which are capable of ensuring the stability of a distribution method.

In accordance with an aspect of the present invention, there is provided a method by which a terminal receives contents over an overlay network, the method including receiving notification of a content distribution plan, including information about an ID of specific content, overlay network ID information for the specific content, and an address of a tracker server function unit of a contents server for the overlay network, from the contents server or another terminal within the overlay network; receiving a list of terminals, included in the overlay network identified by the overlay network ID information, or a list of terminals, managed by the tracker server function unit identified by the address of the tracker server function unit, from the contents server or the other terminal; receiving held content information, indicating whether or not the specific content is held, from one or more of the terminals within the list; and receiving the specific content from the one or more terminals based on the held content information.

The method may further include sending a reception completion message to the contents server when the specific content is received; and receiving a reception completion acknowledgement message indicative that the reception completion message has been received from the contents server.

The reception completion message may include one or more of a method of receiving the specific content, a reception start time of the specific content, a reception completion time of the specific content, an average transmission speed and average reception speed of the specific content, and information about the sharing of the specific content.

Until the reception completion acknowledgement message is received, receiving the held content information may include receiving the held content information at predetermined time intervals a previously stored number of times, and receiving the specific content may include receiving the specific content based on the received held content information; and the previously stored time interval and the previously stored number of times may be stored in the content distribution plan.

The content distribution plan may further include a transmission deadline by which the reception of the specific content needs to be completed and an address of an alternative content server function unit of the contents server from which the specific content is to be received if the reception of the specific content has not been completed by the transmission deadline; and the transmission deadline may include one or more of a primary transmission deadline and a secondary transmission deadline.

The method may further include sending a warning message to all the terminals within the list and the contents server if the reception of the specific content has not been completed by the primary transmission deadline; receiving a warning acknowledgement message, indicative that the warning message has been received from a terminal that belongs to all the terminals that have received the warning message and that has the specific content; receiving held content information of the specific content from one or more of terminals that have sent the warning acknowledgement messages; and receiving the specific content from the one or more terminals based on the held content information.

The method may further include, if the reception of the specific content has not been completed by the secondary transmission deadline, accessing the alternative content server function unit and receiving the specific content, or allowing the alternative content server function unit to upload the specific content.

The method may further include receiving the specific content from a terminal having a fastest network average speed based on the network average speed information of all the terminals within the list from the contents server.

The content distribution plan may include information about the priority of the specific content; and receiving the specific content may include comparing the priority of the specific content with the priorities of other pieces of content, and receiving the specific content based on the results of the comparison.

In accordance with another aspect of the present invention, there is provided a method by which a contents server sends contents to a terminal over an overlay network, the method including configuring, by the contents server, the overlay network for specific content; setting up a content distribution plan of the specific content over the configured overlay network; generating a list of terminals, included in the overlay network identified by overlay network ID information included in the content distribution plan, or a list of terminals managed by a tracker server function unit identified by an address of the tracker server function unit of the contents server included in the content distribution plan; notifying one or more of the terminals within the list of the content distribution; sending the list of terminal to the one or more of the terminals within the list; sending held content information, indicating whether or not the specific content is held, to one or more of the terminals within the list; and sending the specific content to a terminal that has received the held content information.

The method may further include receiving a reception completion message from a terminal to which the transmission of the specific content has been completed when the transmission of the specific content is completed; recording the reception completion message; and sending a reception completion acknowledgement message, indicative that the reception completion message has been received, to the terminal to which the transmission of the specific content has been completed.

The content distribution plan may further include a transmission deadline by which the transmission of the specific content needs to be completed, and an address of an alternative server function unit of the contents server from which the specific content is to be received if the transmission of the specific content has not been completed by the transmission deadline; and the transmission deadline may include one or more of a primary transmission deadline and a secondary transmission deadline.

The method may further include receiving a warning message from a terminal to which the transmission of the specific content has not been completed by the primary transmission deadline; receiving held content information of the specific content from the terminal to which the transmission of the specific content has not been completed; and sending the specific content to the terminal to which the transmission of the specific content has not been completed based on the received held content information.

The method may further include, if the transmission of the specific content has not been completed by the secondary transmission deadline, allowing a terminal to which the transmission of the specific content has not been completed to access an alternative content server function unit and receive the specific content from the alternative content server function unit, or allowing the alternative content server function unit to upload the specific content to the terminal to which the transmission of the specific content has not been completed.

The method may further include receiving network average speed information at which the specific content is received from all the terminals within the list; and transferring the network average speed information of all the terminals to one or more of the terminals within the list.

The content distribution plan may include information about the priority of the specific content; and sending the specific content may include comparing the priority of the specific content with the priorities of other pieces of content, and sending the specific content based on the results of the comparison.

In accordance with still another aspect of the present invention, there is provided a digital display terminal, including a content distribution management unit configured to receive notification of a content distribution plan, including information about an ID of the specific content, overlay network ID information for the specific content, and an address of a tracker server function unit of a contents server for the overlay network from the contents server or another terminal within the overlay network; and a content distribution peer configured to receive a list of terminals, included in the overlay network identified by the overlay network ID information, or a list of terminals, managed by the tracker server function unit identified by the address of the tracker server function unit, from the contents server or the other terminal, to receive held content information, indicating whether or not the specific content is held, from one or more of the terminals within the list, and to receive the specific content from the one or more terminals based on the held content information.

The content distribution plan may further include a transmission deadline by which the reception of the specific content needs to be completed, and an address of an alternative server function unit of the contents server from which the specific content is to be received if the reception of the specific content has not been completed by the transmission deadline; and the transmission deadline may include one or more of a primary transmission deadline and a secondary transmission deadline.

The digital display terminal may further include a warning message transmission/reception unit configured to send a warning message to all the terminals within the list and the contents server if the reception of the specific content has not been completed by the primary transmission deadline, and to receive a warning acknowledgement message, indicative that the warning message has been received from a terminal that belongs to all the terminals that have received the warning message and that has the specific content; the content distribution peer may receive held content information of the specific content from one or more of terminals that have sent the warning acknowledgement messages, and may receive the specific content from the one or more terminals based on the held content information.

The digital display terminal may further include, if the reception of the specific content has not been completed by the secondary transmission deadline, a terminal alternative server configured to access an alternative server function unit of the contents server and to receive the specific content, or configured to receive the specific content uploaded by the alternative server function unit.

The terminal alternative server, if a number of terminals having the specific content is smaller than a predetermined number as a result of analysis of the held content information, may allow the alternative server function unit of the contents server to be accessed and the specific content to be received from the alternative server function unit or may allow the specific content to be uploaded via the alternative server function unit of the contents server.

The digital display terminal may further include a network speed information transmission/reception unit configured to send network average speed information at which the specific content is received to the contents server and to receive pieces of network average speed information of all the terminals within the list from the contents server; the content distribution peer may receive the specific content from a terminal that belongs to terminals having the specific content and that has a fastest network average speed the terminal.

The content distribution plan may include information about the priority of the specific content; and the content distribution peer may compare the priority of the specific content with the priorities of other pieces of content, and receives the specific content based on results of the comparison.

The content distribution peer, when the reception of the specific content is completed, may send a reception completion message to the contents server and receive a reception completion acknowledgement message, indicative that the reception completion message has been received, from the contents server.

The content distribution peer may repeat an operation of receiving the held content information and an operation of receiving the specific content a predetermined number of times at predetermined time intervals until the reception completion acknowledgement message is received; and the predetermined time intervals and the predetermined number of times may be additionally included in the content distribution plan.

In accordance with still another aspect of the present invention, there is provided a contents server, including a content distribution policy management unit configured to configure an overlay network for specific content, to set up a content distribution plan of the specific content, and to notify one or more of terminals included in the overlay network of the generated content distribution plan; a tracker server function unit configured to generate a list of terminals included in the overlay network, and to send the list to one or more of the terminals within the list; and a content distribution peer configured to send held content information, indicating whether or not the specific content is held, to one or more of the terminals within the list, and to send the specific content to a terminal that has sent the held content information; wherein the content distribution plan comprises information about an ID of the specific content, overlay network ID information for the specific content, and an address of a tracker server function unit; and wherein the list comprises a list of terminals included in the overlay network identified by the overlay network ID information or a list of terminals managed by the tracker server function unit identified by the address of the tracker server function unit.

The content distribution plan may further include a transmission deadline by which the transmission of the specific content needs to be completed, and an address of an alternative server function unit of the contents server from which the specific content is to be received if the transmission of the specific content has not been completed by the transmission deadline; and the transmission deadline may include one or more of a primary transmission deadline and a secondary transmission deadline.

The contents server may further include a warning message transmission/reception unit configured to receive a warning message from a terminal to which the transmission of the specific content has not been completed by the primary transmission deadline; the content distribution peer may receive held content information of the specific content from the terminal to which the transmission of the specific content has not been completed, and may send the specific content to the terminal to which the transmission of the specific content has not been completed based on the received held content information.

The contents server may further include an alternative server function unit configured to, if the transmission of the specific content has not been completed by the secondary transmission deadline, allow a terminal to which the transmission of the specific content has not been completed to directly access the alternative server function unit and to receive the specific content from the alternative server function unit, or configured to upload the specific content to the terminal to which the transmission of the specific content has not been completed.

The alternative server function unit, if a number of terminals having the specific content in the overlay network for the specific content is smaller than a predetermined number, may allow one or more of the terminals within the overlay network to access the alternative server function unit and to receive the specific content, or may upload the specific content to the one or more terminals.

The contents server may further include a network speed information transmission/reception unit configured to receive network average speed information at which the specific content is received from all the terminals within the list, and to transfer the network average speed information of all the terminals to one or more of the terminals within the list.

The content distribution plan may include information about the priority of the specific content; and the content distribution peer may compare the priority of the specific content with the priorities of other pieces of content and receive the specific content based on results of the comparison.

The contents server may further include a content distribution log recording unit configured to, if the transmission of the specific content has been completed, receive a reception completion message from a terminal to which the transmission of the specific content has been completed, record the received reception completion message, and send a reception completion acknowledgement message, indicative that the reception completion message has been received, to the terminal to which the transmission of the specific content has been completed.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are diagrams illustrating a network to which the present invention may be applied;

FIG. 2 is a diagram illustrating the overall configuration of an embodiment of the present invention;

FIG. 3 is a diagram illustrating an overlay network according to an embodiment of the present invention;

FIG. 4 is a diagram illustrating an embodiment of a content distribution plan according to an embodiment of the present invention;

FIG. 5 is a diagram illustrating a transmission deadline according to an embodiment of the present invention;

FIG. 6 is a diagram illustrating an operation that is performed when the reception of specific content is not completed by a primary transmission deadline illustrated in FIG. 5;

FIG. 7 is a diagram illustrating an operation that is performed when the reception of specific content is not completed by a secondary transmission deadline illustrated in FIG. 5;

FIG. 8 is a diagram illustrating an embodiment of the case where pieces of information about network average speeds are exchanged;

FIGS. 9A and 9B are diagrams illustrating the efficiency based on the number of content holding terminals within an overlay network according to an embodiment of the present invention;

FIG. 10 is a diagram illustrating an embodiment of an operation in the case where the transmission of specific content has been completed;

FIG. 11 is a diagram illustrating an embodiment in which a content distribution plan or a list of terminals is transmitted between terminals;

FIG. 12 is a diagram illustrating an embodiment of a contents server according to an embodiment of the present invention;

FIG. 13 is a diagram illustrating an embodiment of a terminal according to an embodiment of the present invention;

FIG. 14 is a diagram illustrating an embodiment of a method of sending and receiving content according to an embodiment of the present invention;

FIG. 15 is a diagram illustrating an embodiment of an operation when the reception of specific content is not completed by the primary transmission deadline of FIG. 14;

FIGS. 16A and 16B are detailed diagrams illustrating a method of receiving content according to an embodiment of the present invention;

FIG. 17 is a diagram illustrating an embodiment of a digital display terminal that may be remotely controlled according to an embodiment of the present invention;

FIGS. 18A and 18B are detailed diagrams illustrating a method of sending content according to an embodiment of the present invention; and

FIG. 19 is a diagram illustrating an embodiment of a contents server according to an embodiment of the present invention.

### DESCRIPTION OF THE PREFERRED EMBODIMENTS

The present invention may be modified in various ways, and may have several embodiments. Specific embodiments are illustrated in the drawings and described in detail.

However, it is to be understood that the present invention is not intended to be limited to the specific embodiments of the present invention but the specific embodiments include all modifications, equivalents to alternatives which fall within the spirit and technical scope of the present invention.

Terms used in this application are used to only describe the specific embodiments, and are not intended to restrict the present invention. Terms used in the singular include the plural unless clearly defined otherwise in the context. In this application, terms, such as “comprise” or “have,” are intended to designate that characteristics, numbers, steps, operations, elements, or parts which are described in the specification, or a combination of them exist, and should not be understood that they exclude the existence or possible addition of one or more other characteristics, numbers, steps, operations, elements, parts, or combinations of them in advance.

All terms used herein, unless otherwise defined, have the same meanings as those typically understood by those having ordinary skill in the art. The terms, such as ones defined in common dictionaries, should be interpreted to have the same meanings as terms in the context of pertinent technology, and should not be interpreted to have ideal or excessively formal meanings unless clearly defined in the specification.

Embodiments of the present invention are described in more detail below with reference to the accompanying drawings. In the following description of the present invention, in order to help the overall understanding of the present invention, the same reference numerals are used to denote the same elements throughout the drawings, and redundant descriptions of the same elements are omitted.

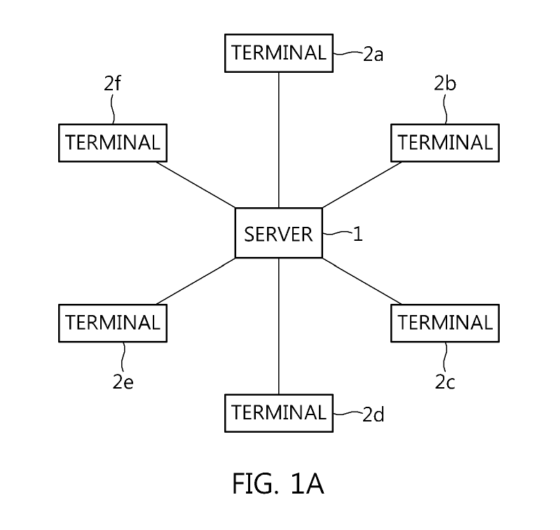

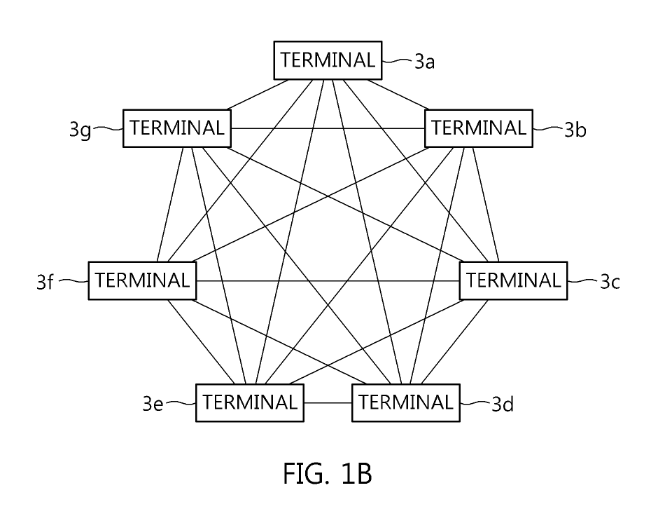

FIGS. 1A and 1B are diagrams illustrating a network to which the present invention may be applied. A P2P network has a form in which personal computers or terminals directly connect to each other and mutually search each other; and thus all peers become suppliers and consumers, unlike in a conventional server-client concept or a content supplier-consumer concept.

FIG. 1A illustrates a conventional server-based network. A server 1 placed at the center of the network may have all content to be distributed. If content needs to be received, each of terminals 2a to 2f may access the server 1, and may receive required content from the server 1. All the terminals 2a to 2f may be provided with content via only the server 1.

Accordingly, if a large amount of content needs to be distributed or a large number of terminals desire to receive the same content at the same time, a bottleneck may occur at the server 1. Accordingly, an excessive load may be generated from the viewpoint of the server, and a disadvantage may occur in reception speed upon receiving required content from the viewpoint of the terminals.

FIG. 1B illustrates a P2P network. Terminals 3a to 3g may be connected to each other. Each of the terminals 3a to 3g may become a supplier and a consumer of content. If content is required, each of the terminals 3a to 3g may access other terminals, search other terminals for the required content, and may exchange the required content with other terminals.

The P2P network may be less problematic than the server-based network (refer to FIG. 1A) in terms of a speed reduction attributable to the load of a server. In contrast, the P2P network may be problematic in that mutual searching between terminals is difficult and the load of the network itself must be overcome.

In the case of the P2P network, a server may function as a first supplier of content. A tracker server may be provided in the P2P network. The tracker server is a type of server, and may function to monitor and manage peers within the P2P network.

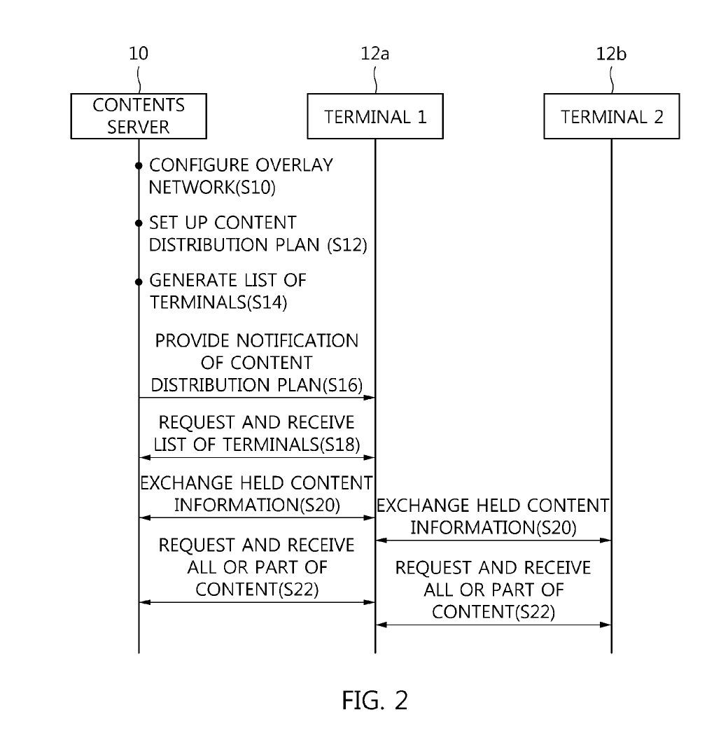

FIG. 2 is a diagram illustrating the overall configuration of an embodiment of the present invention.

In this embodiment of the present invention, content to be played back in each terminal may be distributed by applying the above-described P2P network to a digital signage environment.

In FIG. 2, a contents server 10 may be a server functioning as the first supplier of the above-described P2P network. The contents server 10 may be formed of an overlay network for content to be delivered, and may notify terminals 12a and 12b of a content distribution plan.

The terminals 12a and 12b may be peers on the above-described P2P network. In a digital signage environment, the terminals 12a and 12b may correspond to respective digital displays. Accordingly, the terminals 12a and 12b in the digital signage environment may be referred to as digital signage terminals or digital display terminals. The terminals 12a and 12b are connected over a network, and may be remotely controlled.

The contents server 10 may provide each of the terminals 12a and 12b with content to be played back using various methods. Furthermore, the contents server 10 may manage the terminals 12a and 12b.

The general configuration of this embodiment of the present invention illustrated in FIG. 2 may include configuring an overlay network at step S10, setting up a content distribution plan at step S12, generating a list of terminals at step S14, providing notification of the content distribution plan at step S16, requesting and receiving the list of terminals at step S18, exchanging held content information at step S20 and/or requesting and receiving all or part of the content at step S22.

First, configuring the overlay network at step S10 may include configuring the overlay network for specific content to be transmitted by the contents server 10. The overlay network may be a network having all or part of the same content or a virtual network including information about the network addresses (e.g., IPs or ports) of terminals that receive content. In order to distribute content using a P2P method, the overlay network needs to be configured, which is described in detail later.

Generating the content distribution plan at step S12 may include setting up the content distribution plan for distributing specific content to be transmitted by the contents server 10. The term “content distribution plan” refers to a plan for distributing specific content or information required for the distribution. The content distribution plan may include information about specific content, a content distribution method, and/or information about an overlay network, which are described in detail later.

At step S14 of generating the list of terminals, the contents server 10 induces terminals (e.g., the terminal 1 12a and the terminal 2 12b) over which corresponding content needs to be distributed to participate in the overlay network according to the generated content distribution plan, and prepares a list of terminals (e.g., the terminal 1 12a and the terminal 2 12b) within the overlay network. The terminals (e.g., the terminal 1 12a and the terminal 2 12b) may be terminals that are managed by the tracker server function unit (not shown) of the contents server 10. The tracker server function unit is described later. In a common P2P environment, all peers may not be managed. The reason for this is that, in the common P2P environment, peers continue to participate in and withdraw from an overlay network. In the digital signage environment, however, the contents server 10 may previously induce the terminals (e.g., the terminal 1 12a and the terminal 2 12b) over which specific content needs to be distributed to participate in the overlay network because peers are also terminals and all the terminals are managed by a service provider. Accordingly, unlike in a common P2P environment, in the digital signage environment, a participation/secession process may not be required. Accordingly, a separate process, such as the transmission of a participation message or a participation notification, may not be required. In an embodiment of the present invention, all the terminals (e.g., the terminal 1 12 and the terminals 2 12b) may be terminals managed by the contents server (or the service provider) 10. Accordingly, the contents server 10 may prepare a list of terminals (e.g., the terminal 1 12 and the terminals 2 12b) within the overlay network. Such a characteristic is advantageous in that the distribution of content may be stably performed in a digital signage environment in which each of display terminals (e.g., the terminal 1 12 and the terminals 2 12b) needs to be managed and content needs to be played back at a predetermined time.

According to a situation, after an overlay network has been configured and terminals (e.g., the terminal 1 12 and the terminals 2 12b) have previously participated in the overlay network, new terminals may be added. In such a case, like in common P2P, a separate participation notification process may be required. In this case, the participation notification process may comply with a participation notification process in a common P2P environment.

The list of terminals may include the network addresses of terminals (e.g., the terminal 1 12 and the terminals 2 12b) that have participated in the overlay network configured by the contents server 10. The list of terminals may include other information about the terminals (e.g., the terminal 1 12 and the terminals 2 12b).

Generating the list of terminals at step S14 may be performed after receiving a request for the list of terminals at step S18 of requesting and receiving the list of terminals. That is, after a request for the list of terminals has been received, the list of terminals may be generated and sent to the terminals.

The list of terminals may be included in the content distribution plan. In this case, when the content distribution plan is generated, it may be generated along with the list of terminals, and the list of terminals may be included in the generated content distribution plan. When notification of the content distribution plan is provided, the list of terminals may be transferred. In such a case, requesting and receiving the list of terminals at step S18 may be omitted.

At step S16 of providing notification of the content distribution plan, the contents server 10 notifies terminals (e.g., the terminal 1 12 and the terminals 2 12b) of the content distribution plan. The contents server 10 may notify all terminals, managed by the contents server 10, of a plurality of content distribution plans generated in connection with a plurality of pieces of content, and may notify only terminals needing to receive specific content of the content distribution plan of the specific content. A method of providing notification of the content distribution plan may be a common method in a corresponding technical field. In an embodiment of the present invention, if notification of the content distribution plan is not provided, the terminal (i.e., the terminal 1 12a or the terminal 2 12b) may request the content distribution plan from the contents server 10. In an embodiment of the present invention, the content distribution plan may be received from another terminal. The content distribution plan is described later.

At step S18 of requesting and receiving the list of terminals, terminals (e.g., the terminal 1 12 and the terminals 2 12b) request the list of terminals from the contents server 10, and receive the list of terminals from the contents server 10. The terminals that have been notified of the content distribution plan may access the overlay network for the specific content using information about the overlay network that is included in the content distribution plan. The terminals (e.g., the terminal 1 12 and the terminals 2 12b) may access the contents server (or the tracker server function unit of the contents server) 10, and may request and receive the list of terminals from the contents server. The terminals (e.g., the terminal 1 12 and the terminals 2 12b) may obtain the network addresses of other terminals within the overlay network via the list of terminals. As described above, since terminals (e.g., the terminal 1 12 and the terminals 2 12b) previously participate in the overlay network, a separate participation notification may not be required. Accordingly, the request and reception of the list of terminals may be only performed to obtain the network addresses of the terminals.

In the above-described embodiment, if a new terminal is subsequently added, a separate participation notification process may be required so that the new terminal participates in the overlay network.

Exchanging the held content information at step S20 includes accessing the list of terminals and exchanging information about specific content that is possessed by another terminal within the overlay network. If another terminal (e.g., the terminal 1 12b) within the overlay network requests the held content information of a current terminal (e.g., the terminal 1 12a), the current terminal may send its held content information to another terminal (e.g., the terminal 1 12b). Furthermore, the current terminal 12a may request and receive the held content information of another terminal 12b within the overlay network. The contents server 10 may also function as a peer within the overlay network. The role as a peer may be played by a content distribution peer module (not shown) within the contents server 10. The contents server 10 may exchange held content information with the current terminal 12a as in another terminal 12b within the overlay network. The contents server 10 may have the overall content as the first distributor of the content. Accordingly, the held content information of the contents server 10 may indicate that the contents server 10 retains all the fragments of corresponding content. In this case, the held content information may be information indicating whether terminals (e.g., the terminal 1 12 and the terminals 2 12b) or the contents server 10 have held all or part of specific content. Furthermore, the held content information may be information about the content fragments of held specific content. In FIG. 2, only one terminal 12b within the overlay network has been illustrated, but the number of terminals may be plural.

At step S22 of requesting/receiving all or part of the content, a terminal (e.g., the terminal 12a) exchanges all or part of the content with another terminal (e.g., the terminal 12b) within the overlay network or the contents server 10 according to the held content information. If it is determined based on the held content information received from another terminal (e.g., the terminal 12b) within the overlay network that there is the other terminal (e.g., the terminal 12b) that has all or part (content fragments) of the content that is not possessed by the current terminal (e.g., the terminal 12a), the terminal (e.g., the terminal 12a) may request and receive the corresponding content from the terminal (e.g., 12b). In this case, the corresponding content may be the content fragments of the corresponding content. Likewise, if another terminal (e.g., 12b) within the overlay network requests all or part (content fragments) of the content, possessed by the current terminal 12a, from the current terminal (e.g., 12a), the current terminal 12a may send all or part (content fragments) the content to the other terminal 12b. As described above, since the contents server 10 also functions as a peer within the overlay network, the exchange of all or part of the content may be performed even in connection with the contents server 10. However, since the contents server 10 has the overall content, the contents server 10 may not request content from the terminals (e.g., the terminal 1 12 and the terminals 2 12b).

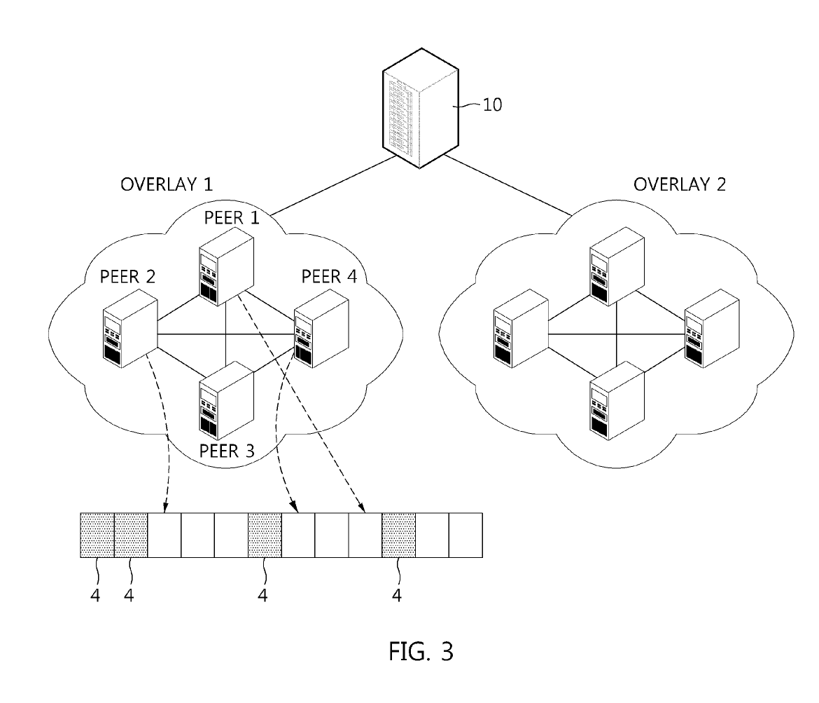

FIG. 3 is a diagram illustrating an overlay network according to an embodiment of the present invention. FIG. 3 illustrates the overlay network managed by the contents server 10.

The contents server 10 of FIG. 3 may be a tracker server. In this case, the tracker server may correspond to the tracker server function unit of the contents server 10. The overlay 1 may be an overlay network generated in relation to specific content. The overlay 2 may be another overlay network generated in connection with another specific content. A peer within the overlay network is a peer within the overlay network, and may be a content distribution peer module within a terminal or the contents server.

The contents server 10 may configure an overlay network for each piece of content to be distributed. Each overlay network may be generated for each piece of content. However, a single overlay network may be configured for a group of pieces of content. In this case, each overlay network may have a unique ID.

The number of pieces of content to be received by a terminal may be plural. Accordingly, a single terminal may be simultaneously included in multiple overlay networks. The reason for this is that an overlay network may be present for each piece of content or for each content group.

The contents server 10 may logically divide content to be distributed into a plurality of fragments (or pieces). In this case, the contents server 10 may divide the content into a plurality of fragments having the same size. For example, when a fragment number is 2 and the size of the fragment is 1 M, this may be the 1 to 2 M data of actual content.

In FIG. 3, a fragment 4 may be a content fragment already possessed by a terminal (i.e., PEER3). The remaining fragments may be content fragments not possessed by the terminal (i.e., PEER3). The remaining fragment other than the fragment 4 may be received from other terminals PEER1, PEER2 and PEER4 which have the remaining fragments.

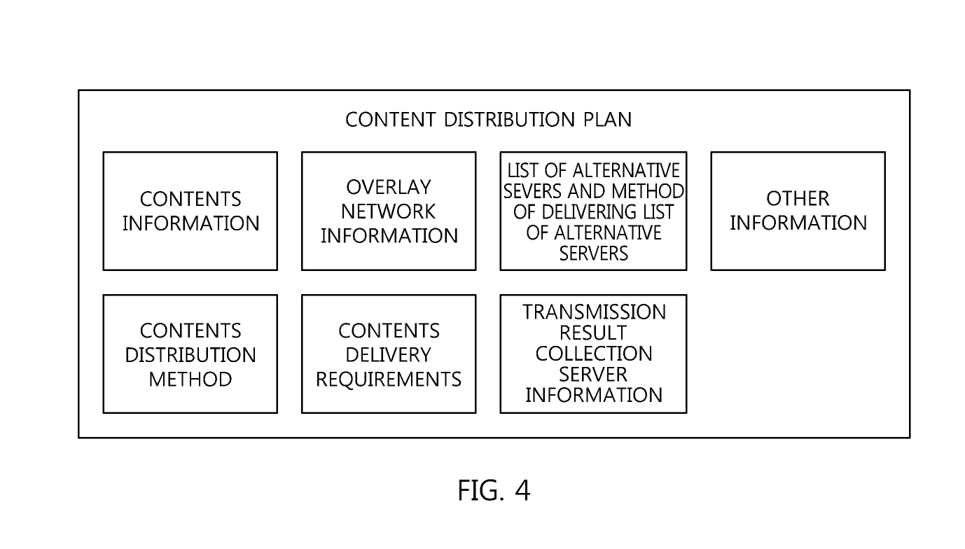

FIG. 4 is a diagram illustrating a content distribution plan according to an embodiment of the present invention. As described above, the contents server 10 generates a content distribution plan for distributing specific content to be transmitted.

The content distribution plan may include information about contents, a contents distribution method, information about an overlay network, a list of alternative servers and a method of transferring the list, contents delivery requirements, and/or information about a transmission result collection server.

The contents information may include a content ID and a content access address (URI). In an embodiment of the present invention, the content distribution plan may be generated in relation to a plurality of pieces of content. In this case, all the IDs of a plurality of content groups or the ID of the IDs of a plurality of pieces of content may be included in the content distribution plan.

The contents distribution method may include a pull method (e.g., an HTTP and FTP method), a push method and a P2P method. In addition, the contents distribution method may include common contents distribution methods in the corresponding technical field. In content distribution, content reception rights may be assigned if required. In such a case, in order to receive content, an ID and a password may be set. The reception of content by a terminal having no content reception rights may be limited. Furthermore, information about a content reception start time may be set. In this case, the reception of content may be performed after the content reception start time.

The overlay network information may include an overlay network ID. In this case, if a content ID may sufficiently guarantee specificity or uniqueness, the content ID may be used as the overlay network ID. The overlay network information may further include the address of a tracker server function unit. A terminal that has been notified of a content distribution plan may access a tracker server function unit using the address of the tracker server function unit that is included in the content distribution plan. The terminal may access the tracker server function unit, and may obtain a list of terminals that are included in or are to be included in an overlay network or the network addresses of terminals that are included in or are to be included in an overlay network. The content distribution plan may include a list of terminals that are included in or are to be included in an overlay network or the addresses of terminals that are included in or are to be included in an overlay network. If a list of terminals that are included in or are to be included in an overlay network is included in the content distribution plan, the terminal may not request the list of terminals from the contents server subsequently.

The content distribution plan may include a list of alternative servers and a method of delivering the list via an alternative server. The alternative server may be an alternative server within a contents server to be described later. If a terminal does not receive content using a P2P method by a transmission deadline, the terminal may access an alternative server and directly receive the content using a push or pull method. The alternative server may include a contents distribution pull server function entity “DSContDistPullSvr FE” and/or a content distribution push client “DSContDistPushCli FE.” The DSContDistPullSvr FE may enable a terminal to receive content using the pull method. The DSContDistPushCli FE may enable a contents server to upload content to a terminal using the push method. The DSContDistPullSvr FE and the DSContDistPushCli FE are described later. Furthermore, in accordance with an embodiment of the present invention, if the number of terminals (peers) that have specific content within an overlay network is smaller than a predetermined number, a terminal may access an alternative server and directly receive content from the alternative server. This is described later.

The content delivery requirements may include a content transmission deadline, and an operation that is performed when content is not received. In this case, the content transmission deadline may be a point of time at which the transmission of content needs to be completed. The number of transmission deadlines may be plural. In an embodiment of the present invention, the transmission deadline may include a primary transmission deadline and/or a secondary transmission deadline. In this case, the operation that is performed when content is not received may be an operation that needs to be performed when the content has not been received by a transmission deadline. A service provider may previously designate a transmission deadline and an operation that is performed when content is not received according to the transmission deadline. The operation that is performed when content is not received may include the replacement of a reception method and a notification to an administrator. If an operation that is performed when content is not received is generated, information about the operation that is performed when content is not received and related operation details may be sent to a contents server (or the content distribution log server function unit of the contents server) and recorded. If the number of transmission deadlines is plural, the number of operations that are performed when content is not received may be plural. The reason why the number of transmission deadlines and the number of operations when content is not received are plural is to enable various operation scenarios to be generated according to circumstances. For example, various types of transmission deadlines ranging from a transmission deadline at a simple warning level to a critical transmission deadline that must be kept may be set.

The information about a transmission result collection server may mean information about the content distribution log server function unit of a contents server. If the reception of specific content has been completed, a terminal may report a content reception result to the content distribution log server function unit. The network address of the content distribution log server function unit may be included in the information about a transmission result collection server. Furthermore, the information about a transmission result collection server may include information about the case where a report needs to be made to the content distribution log server function unit. That is, the information about a transmission result collection server may include information about the method and type of report.

The content distribution plan may include information about the priority of content. The information about the priority of content is information indicative of priority on which specific content needs to be transmitted to a terminal. Content that must be transmitted may have high priority, and additional content may have low priority. The priority may be assigned by a service provider according to circumstances. The priority may be formed of a real number, percentage or text, such as “high”, “middle” and “low.” For example, if content has priority of “high,” the content may be received over another piece of content having priority of “middle” or “low.” A terminal may receive a plurality of pieces of content at the same time according to circumstances. The pieces of content may have different priorities for a reason of a business contract or for a reason, such as the importance of content, the degree of urgency of content playback, or a system. Accordingly, different priority is assigned to content.

The content distribution plan may further include various types of information related to the distribution of content, such as the size of a content fragment. Data related to the content distribution plan may be included in a play list/play schedule.

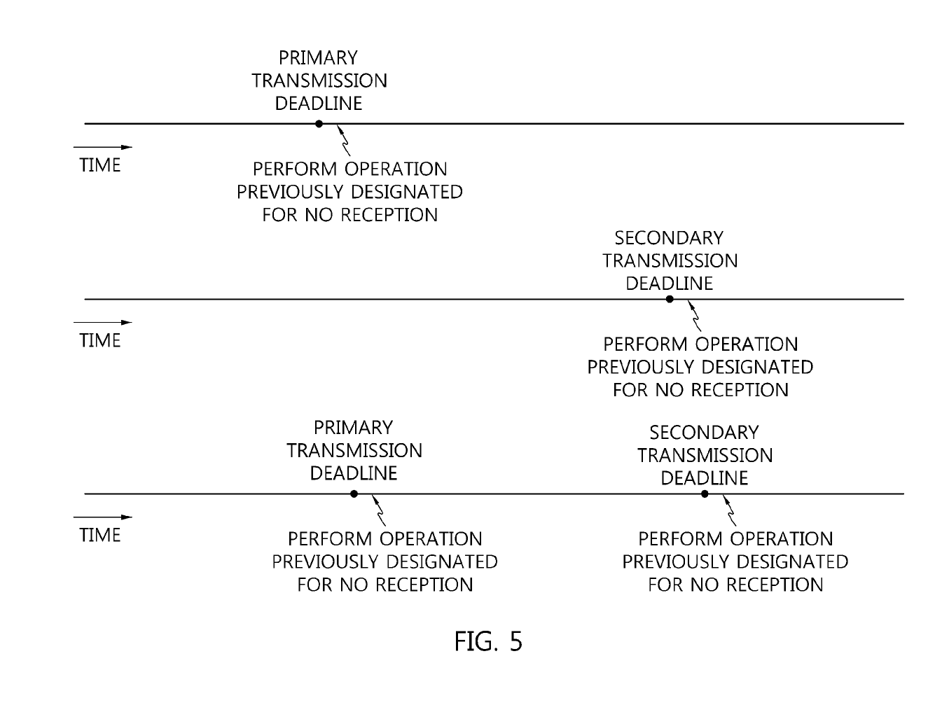

FIG. 5 is a diagram illustrating a transmission deadline according to an embodiment of the present invention.

In the above-described description of the content distribution plan, it has been illustrated that the content delivery requirements include a content transmission deadline and the number of transmission deadlines may be plural. For example, in accordance with an embodiment of the present invention, a transmission deadline may include the primary transmission deadline or the secondary transmission deadline or both. If the reception of content has not been completed by the primary and the secondary transmission deadlines, a predetermined operation that is performed when content is not received may be performed.

The number of transmission deadlines may be two or more according to a designer's intention.

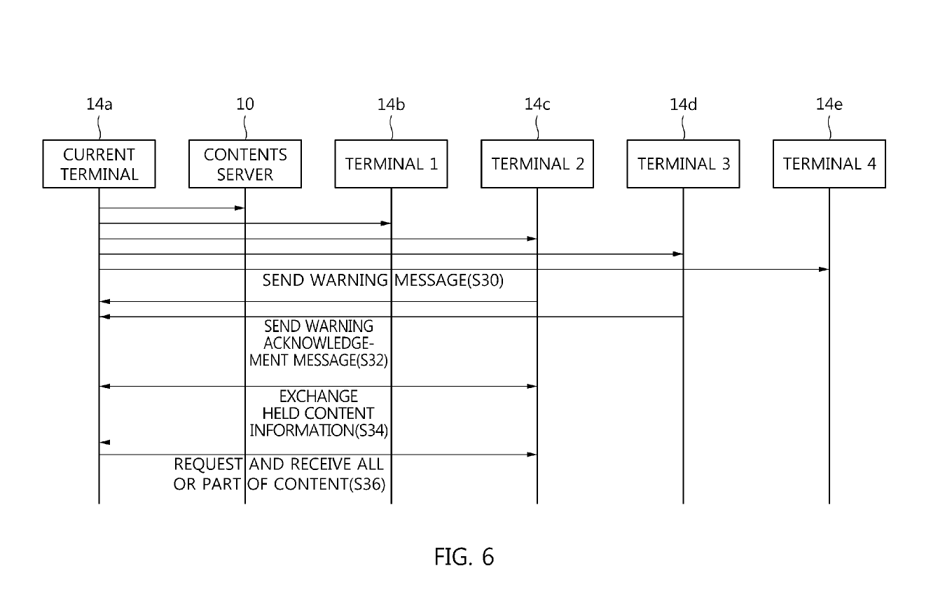

FIG. 6 is a diagram illustrating an operation that is performed when the reception of specific content is not completed by the primary transmission deadline illustrated in FIG. 5.

If the reception of specific content has not been completed by the primary transmission deadline, the operation may include sending a warning message at step S30, sending a warning acknowledgement message at step S32, exchanging held content information at step S34, and/or requesting and receiving all or part of specific content at step S36.

At step S30 of sending the warning message, if a current terminal 14a has not received the specific content by the primary transmission deadline, the current terminal 14a sends the warning message to other terminals 14b to 14e and the contents server 10. The current terminal 14a may send the warning message to all the terminals (i.e., the terminal 1 14b, the terminal 2 14bc, the terminal 3 14d, and the terminal 4 14e) within a list of terminals that has been previously received. All the terminals (i.e., the terminal 1 14b, the terminal 2 14bc, the terminal 3 14d and the terminal 4 14e within the list of terminals may be all terminals that are present in an overlay network for the specific content that has not been received. The current terminal 14a may also send the warning message to the contents server 10. The warning message may include information about the specific content that has not been received by the current terminal 14a.

At step S32 of sending the warning acknowledgement message, terminals (e.g., the terminal 2 14c, and the terminal 3 14d) that have all or part of specific content and that belong to the terminals (i.e., the terminal 1 14b, the terminal 2 14bc, the terminal 3 14d, and the terminal 4 14e) that have received the warning message send the warning acknowledgement messages to the terminal (i.e., the current terminal) 14a that has sent the warning message. The warning acknowledgement message may mean that the warning message has been received. The warning acknowledgement message may include held content information of the terminals that have sent the warning acknowledgement messages. The warning acknowledgement message may include the network addresses or network transfer speed of the terminals that send the warning acknowledgement messages. The warning acknowledgement message may include other pieces of information. The contents server 10 may also send a warning acknowledgement message to the terminal (i.e., the current terminal) 14a that has sent the warning message.

At step S34 of exchanging the pieces of held content information, the terminal (i.e., the current terminal) 14a exchanges the held content information with the terminals which have the specific content that has been not been received by the terminal (i.e., the current terminal) 14a. The terminal (i.e., the current terminal) 14a may receive the held content information of the specific content from at least one terminal (e.g., the terminal 2 14c) that have all or part of specific content and that belongs to the terminals (i.e., the terminal 2 14c and the terminal 3 14d) of all the terminals (the terminal 1 14b, the terminal 2 14c, the terminal 3 14d, and the terminal 4 14e) that have received the warning message. In this case, the current terminal 14a may send its held content information to the at least one terminal (e.g., the terminal 2 14c) of the terminals (i.e., the terminal 2, and the terminal 3) which have the specific content. If the warning message includes the held content information of the current terminal 14a, the terminals (i.e., the terminal 2 14c, and the terminal 3 14d) having the specific content may not send the held content information of the current terminal 14a because they already have the held content information of the current terminal 14a via the warning message. Furthermore, if the warning acknowledgement message includes the pieces of held content information of the terminals (i.e., the terminal 2 14c and the terminal 3 14d) having the specific content, the current terminal 14a may not request the pieces of held content information of the terminals (i.e., the terminal 2 14c and the terminal 3 14d) because it already has the pieces of held content information of the terminals (i.e., the terminal 2 14c and the terminal 3 14d) having the specific content via the warning acknowledgement messages.

At step S36 of requesting and receiving all or part of specific content, the current terminal 14a requests all or part of specific content from the at least one terminal (e.g., the terminal 2 14c) of the terminals (i.e., the terminal 2 14c and the terminal 3 14d) having the specific content. Such a request may be based on the held content information received at step S34. The current terminal 14a may receive all or part of specific content from at least one (e.g., the terminal 2 14c) of the terminals (i.e., the terminal 2 14c and the terminal 3 14d) having all or part of specific content. The terminal 2 14c or the terminals (i.e., the terminal 2 14c and the terminal 3 14d) having the specific content may also request and receive the specific content from the current terminal 14a.

In contrast, if the current terminal 14a receives warning messages from other terminals 14b, 14c, 14d and 14d (not shown), the current terminal 14a may send a warning acknowledgement message to a terminal (i.e., at least one of the terminals 14b, 14c, 14d and 14d that have sent the warning messages), may exchange held content information with the terminal that has sent the warning message and request, and may receive all or part of content based on the held content information.

Through the processes, the terminal 14a may inform the contents server 10 and the terminals 14b, 14c, 14d and 14d within the overlay network that it has not received the specific content by the primary transmission deadline. Furthermore, the terminal 14a may rapidly search for a terminal having content to be received over the overlay network, in addition to reception of a simple warning. By obtaining the pieces of held content information of the terminals having the specific content to be received, the current terminal 14a may easily receive the specific content after the transmission deadline. In an embodiment of the present invention, the contents server 10 (or the tracker server function unit of the contents server) that has received the warning message may transfer the warning message to all the terminals within the overlay network for the specific content. In this case, since the contents server 10 managing all the terminals transfers the warning message, the current terminal 14a may easily search for terminals having the specific content more efficiently.

A service provider may receive a warning message and set the primary transmission deadline in order to facilitate distribution using P2P before the critical transmission deadline is reached.

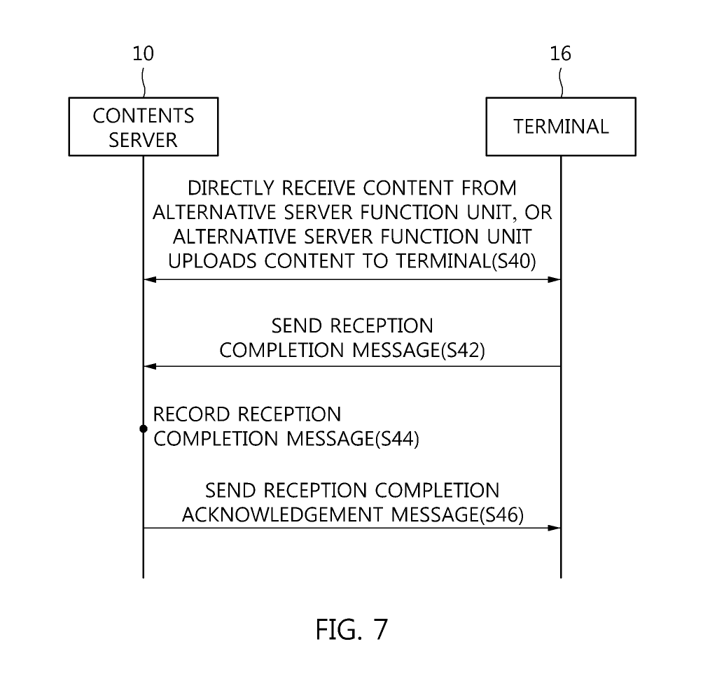

FIG. 7 is a diagram illustrating an operation that is performed when the reception of specific content is not completed by the secondary transmission deadline illustrated in FIG. 5.

If specific content has not been received by the secondary transmission deadline, the operation may include directly receiving the specific content from the alternative server function unit of the contents server 10 or uploading, by the alternative server function unit, the specific content to a terminal 16 at step S40, sending a reception completion message at step S42, recording the reception completion message at step S44, and/or sending a reception completion acknowledgement message at step S46. In this case, sending the reception completion message at step S42, recording the reception completion message at step S44, and sending the reception completion acknowledgement message at step S46 may be omitted according to a designer's intention.

At step S40 of directly receiving the specific content from the alternative content server function unit or uploading, by the alternative content server function unit, the specific content to the terminal, if the reception of the specific content has not been completed by the secondary transmission deadline, the terminal 16 directly receives the specific content. If the reception of the specific content has not been completed by the secondary transmission deadline using a P2P method, the terminal 16 may access the alternative content server function unit (not shown) of the contents server 10. The terminal 16 may directly receive the specific content from the alternative server function unit using a push or pull method. In the pull method, the terminal 16 may directly access the contents server 10 and receive desired content. The push method is a concept symmetrical to the pull method. In the push method, as in a conventional method used in broadcasting, the contents server 10 may send the content of the contents server to the terminal 16 automatically or one-sidedly. The alternative content server function unit of the contents server 10 may include the DSContDistPullSvr FE or the DSContDistPushCli FE or both. The DSContDistPullSvr FE may enable the terminal 16 to receive content using the pull method. The DSContDistPushCli FE may enable the contents server 10 to upload content to the terminal 16 using the push method. Which method will be selected and whether both the methods will be selected may differ depending on the policies of a service provider. Information about the policies may be included in a content distribution plan. The DSContDistPullSvr FE and the DSContDistPushCli FE are described later.

At step S42 of sending the reception completion message, if the specific content has been received via the alternative server function unit, the terminal 16 notifies the contents server 10 that the specific content has been received. The reception completion message may include various types of information, which are described in detail later.

At step S44 of recording the reception completion message, the contents server 10 records and stores the reception completion message and information including the reception completion message. This is described in detail later.

At step S46 of sending the reception completion acknowledgement message, the contents server 10 sends the reception completion acknowledgement message to the terminal 16 that has sent the reception completion message. The reception completion acknowledgement message may mean an acknowledgement indicative that the reception completion message has been received. This is described in detail later.

If a terminal has not received specific content by the secondary transmission deadline through the processes, the terminal may receive the specific content using methods other than a P2P method. In most cases, specific content needs to be played back at a specific time according to the characteristic of digital signage. In this case, if content is distributed using a P2P method, the distribution of the specific content may not be completed by the specific time. In preparation for such a case, if the specific content may be received via the push/pull method, the stability of content distribution may be improved.

Before a critical transmission deadline, a service provider may set the secondary transmission deadline in order to ensure that the distribution of specific content is completed.

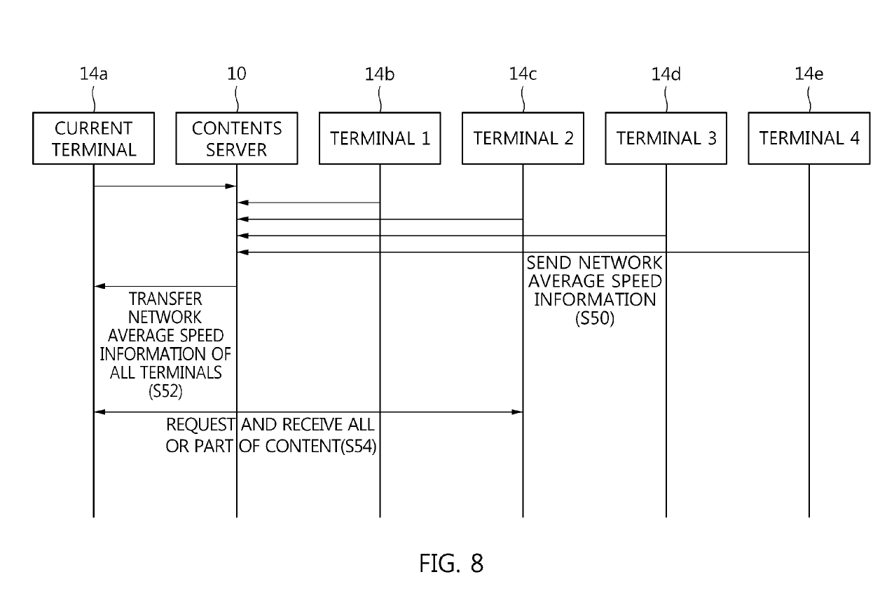

FIG. 8 is a diagram illustrating an embodiment of the case where pieces of information about network average speed are exchanged.

Exchanging pieces of information about network average speed may include sending pieces of information about network average speeds at step S50, transferring the pieces of information about the network average speeds of all terminals at step S52, and/or requesting and receiving all or part of content at step S54.

At step S50 of sending the pieces of information about network average speeds, the terminals 14a, 14b, 14c, 14d and 14e within an overlay network for specific content send their network average speeds to the contents server 10. The network average speed may mean the average value of transmission speeds of the specific content, the average value of reception speeds of the specific content or the average value of transmission and reception speeds of the specific content.

At step S52 of transferring the pieces of information about the network average speeds of all the terminals 14a, 14b, 14c, 14d and 14e, the contents server 10 transfers all the pieces of information about the network average speeds. The contents server 10 may transfer the pieces of information about the network average speeds, received from the terminals 14a, 14b, 14c, 14d and 14e, to a current terminal (e.g., 14a). The contents server 10 may analyze a terminal having the fastest network speed and send average speed analysis information along with the pieces of information about the network average speeds. The average speed analysis information may include information indicative of a terminal having a speed faster than a predetermined speed. The average speed analysis information may include information about a terminal that belongs to all the terminals and that has a network average speed within a predetermined percentage. In this case, information about the network average speed of the current terminal 14a may not be transferred.

At step S54 of requesting and receiving all or part of content, the current terminal (e.g., the current terminal 14a) receives the specific content from a terminal (e.g., the terminal 2 14c) having the fastest network average speed. The current terminal (e.g., the current terminal 14a) may search for the terminal having the fastest network average speed based on average speed information received from the contents server 10. Alternatively, the current terminal (e.g., the current terminal 14a) may search for the terminal having the fastest network average speed based on the average speed analysis information that has been previously analyzed and transmitted by the contents server 10. The current terminal (e.g., the current terminal 14a) may request and receive all or part of specific content from the terminal having the fastest network average speed. In an embodiment of the present invention, the current terminal (e.g., the current terminal 14a) may request and receive all or part of specific content from a terminal having a speed faster than a predetermined speed, in addition to the terminal having the fastest network average speed. In another embodiment of the present invention, the current terminal (e.g., the current terminal 14a) may request and receive all or part of specific content from a terminal that belongs to all the terminals and that has a network average speed within a predetermined percentage. In this case, if a terminal (e.g., the terminal 2 14c) having the fastest network speed requests content from the current terminal 14a, the current terminal 14a may send all or part of content to the terminal (e.g., the terminal 2 14c) having the fastest network speed.

Using such a method, the distribution of content according to a P2P method can be facilitated. The above-described operation may be set as an “operation that is performed when content is not received.” The above-described operation may be more effective because the contents server manages all peers (i.e., terminals) in the use of a P2P method in a digital signage environment.

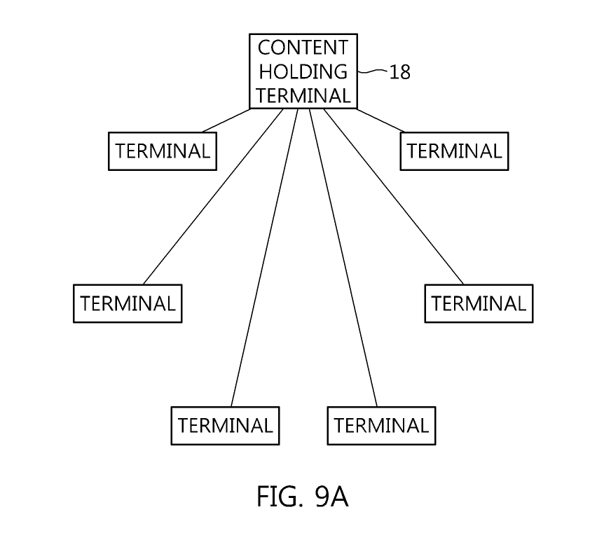

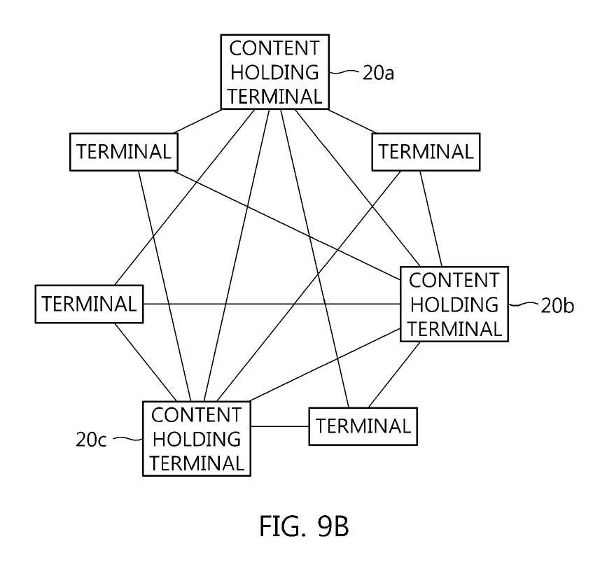

FIGS. 9A and 9B are diagrams illustrating the efficiency based on the number of content holding terminals within an overlay network according to an embodiment of the present invention.

In terms of the characteristics of a P2P method, distribution efficiency exponentially increases according to an increase in the number of peers which have content. If the number of peers is small, however, the distribution efficiency is sharply reduced.

FIG. 9A illustrates the case where the number of content holding terminals is only a terminal 18 when “the number of content holding terminals is small.” Since only the terminal 18 within an overlay network has specific content, all the remaining terminals have to receive the specific content from the terminal 18.

In contrast, FIG. 9B illustrates the case where the number of content holding terminals is three, that is, content holding terminals 20a, 20b and 20c, when “the number of content holding terminals is large.” In this case, the remaining terminals may receive content from the three content holding terminals 20a, 20b and 20c in a distribution manner, thereby being capable of improving distribution efficiency.

In a digital signage environment, the number of peers (i.e., terminals) may be limited. Furthermore, since a contents server distributes content over the terminals, the contents server may be a first content supplier and a unique content holding peer. In order to solve the problem, it is required to rapidly increase the number of terminals having content in a digital signage environment. In an embodiment of the present invention, if, as a result of analysis of received held content information by a terminal, the number of terminals having specific content is smaller than a predetermined number, the terminal may access the above-described alternative content server function unit and receive the specific content, or the alternative content server function unit may directly upload the specific content to the terminal. In this case, a method of receiving or uploading the specific content may be performed using a push or pull method, such as that described above. As a result, distribution efficiency of content using P2P in a digital signage environment can be improved.

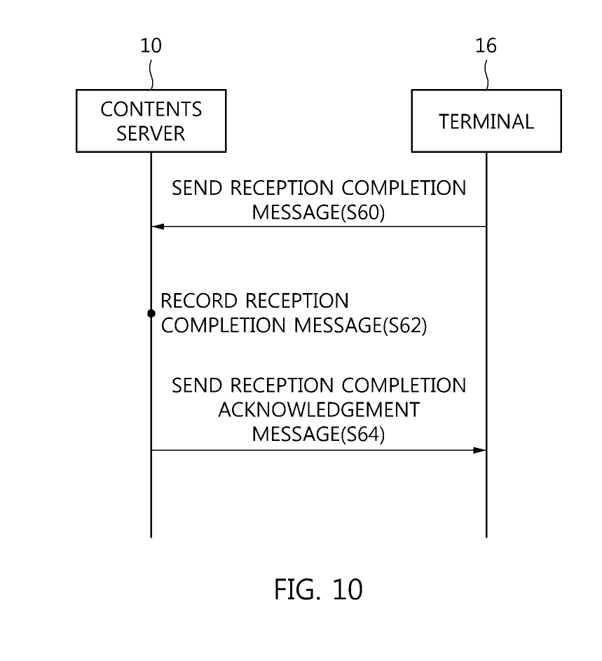

FIG. 10 is a diagram illustrating an embodiment of an operation in the case where the transmission of specific content has been completed.

The operation in the case where the transmission of specific content has been completed may include sending a reception completion message at step S60, recording the reception completion message at step S62, and/or sending a reception completion acknowledgement message at step S64.

At step S60 of sending the reception completion message, a terminal 16 notifies the contents server 10 that the transmission of the specific content has been completed by sending the reception completion message to the contents server 10. In this case, the reception completion message may include at least one of a method of receiving the specific content (e.g., a P2P, HTTP or FTP method), the reception start time of the specific content, the reception completion time of the specific content, the network address of the terminal 16, information about the IP of the network, the average transmission and reception speeds of the specific content, and information about the sharing of the specific content if the specific content is received using a P2P method. The content sharing information may mean pieces of held content information of terminals within an overlay network for the specific content. The held content information may have been obtained when held content information is exchanged.

If the reception of specific content has been completed, such as if the reception of the specific content has been completed by a transmission deadline, if the reception of the specific content has been completed by exchanging pieces of content with terminals having the content after sending a warning message, if the reception of the specific content has been completed by receiving pieces of information about network average speeds and exchanging pieces of content with a terminal having the fastest network average speed, or if the specific content has been directly receive from an alternative content server function unit, the reception completion message may be designed to be transmitted.

At step S62 of recording the reception completion message, the contents server 10 records and stores the reception completion message and information including the reception completion message. Reference may be made to the recorded information for the management of a network, the preparation of a content distribution plan and the management of terminals in the future.

At step S64 of sending the reception completion acknowledgement message, the contents server 10 sends the reception completion acknowledgement message to the terminal 16 that has sent the reception completion message. The reception completion acknowledgement message may be an acknowledgement indicative that the reception completion message has been received. In an embodiment of the present invention, receiving held content information a predetermined number of times and receiving all or part of specific content may be repeated at predetermined time intervals until the reception completion acknowledgement message is received. In this case, the predetermined time intervals and the predetermined number of times may be included in the above-described content distribution plan. If the predetermined time intervals and the predetermined number of times are not included in the content distribution plan, receiving held content information a predetermined number of times and receiving all or part of specific content may be repeated based on predetermined basic values.

A P2P method is basically a delay-tolerant method. In general, in the P2P method, a content completion time is uncertain because there is no deadline for the completion of reception of corresponding content. In a digital signage environment, however, content distribution may require stability because specific content has to be played back at a specific time. Accordingly, for more stable service, a digital signage service provider should be able to check the results of content distribution, and terminals over which content has not been distributed by a specific time may have to receive the content prior to the start of service. Accordingly, in order to ensure stability, if the reception of specific content has been completed, a reception completion message may be transmitted. For clarity, a terminal may also receive a reception completion acknowledgement message.

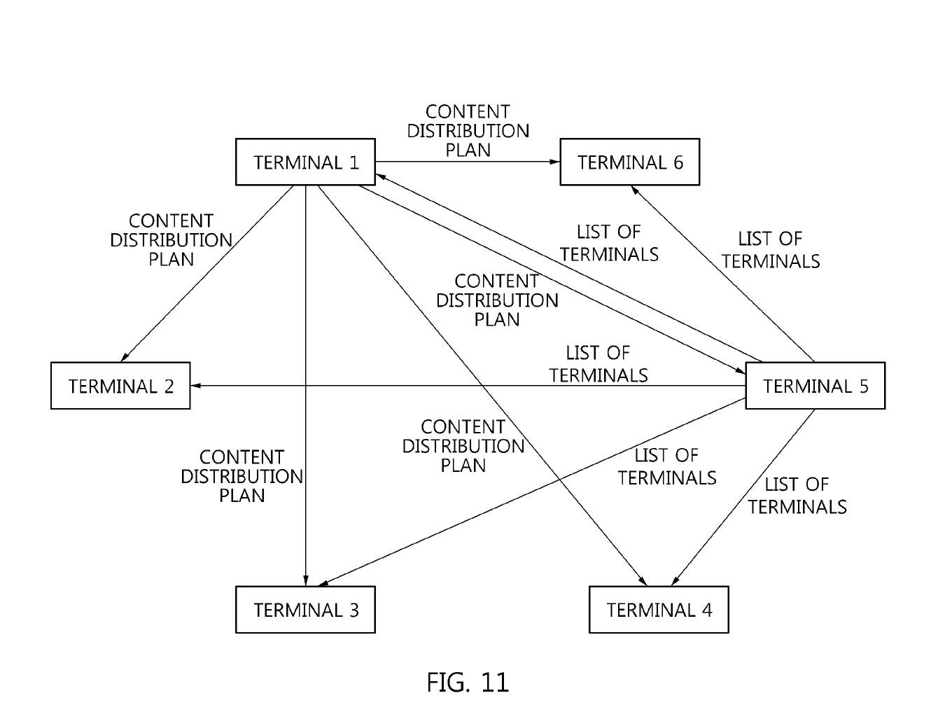

FIG. 11 is a diagram illustrating an embodiment in which a content distribution plan or a list of terminals is transmitted between terminals.

In this embodiment of the present invention, when the contents server notifies a terminal of a content distribution plan or the terminal receives a list of terminals from the contents server, the terminal may transfer the content distribution plan or the list of terminals to another terminal. In this case, another terminal may be a terminal to which specific content related to the content distribution plan or the received list of terminals needs to be distributed. That is, another terminal may be one of terminals within an overlay network related to the specific content.

If a content distribution plan or a list of terminals is transmitted between terminals, a terminal 1 may transfer the content distribution plan, received from the contents server, to terminals 2 to 6. The terminals 2 to 6 that have received the content distribution plan may transfer the content distribution plan to other terminals that have not yet received the content distribution plan. Likewise, the terminal 5 that has received the list of terminals from the contents server may transfer the list of terminals to the terminals 1 to 4 and/or the terminal 6. The terminals 1 to 4 and/or the terminal 6 that have received the list of terminals may transfer the list of terminals to other terminals that have not yet received the list of terminals.

Using the method, the efficiency of the distribution of the content distribution plan or the list of terminals can be improved.

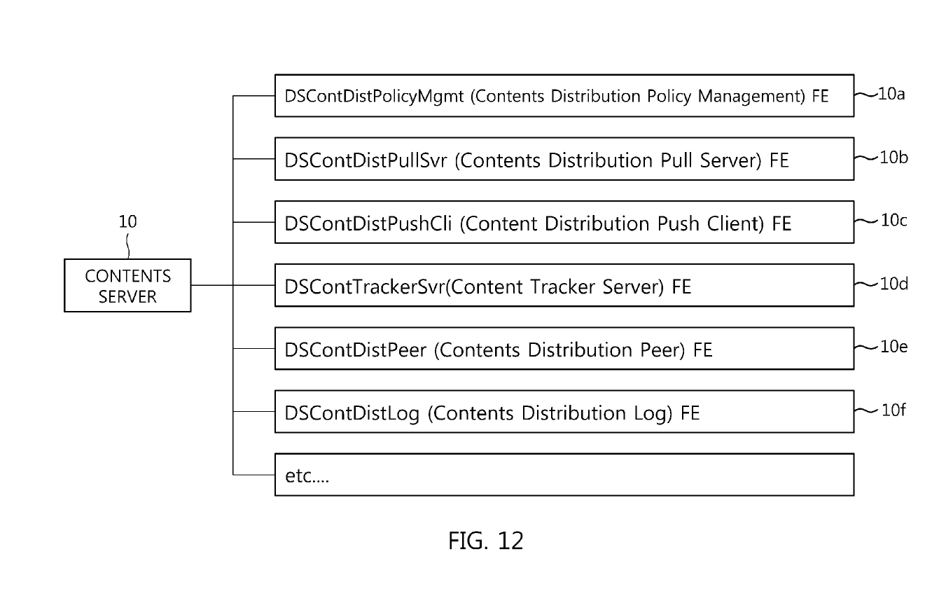

FIG. 12 is a diagram illustrating an embodiment of the contents server according to an embodiment of the present invention.

The contents server 10 according to an embodiment of the present invention may be a server that operates within a P2P network. The contents server 10 may function as the first supplier of content. Furthermore, the contents server 10 may function as a tracker server.

The contents server 10 is described below based on its modules. Each of the modules may be placed within the contents server 10, or may be present outside and physically separate from the contents server 10.

The contents server 10 according to an embodiment of the present invention may include a content distribution policy management function entity (DSContDistPolicyMgmt) FE 10a, a content distribution pull server (DSContDistPullSvr) FE 10b, a content distribution push client (DSContDistPushCli) FE 10c, a content tracker server (DSConttrackerSvr) FE 10d, a content distribution peer (DSContDistpeer) FE 10e, and/or a content distribution log (DSContDistLog) FE 10f.

The DSContDistPullSvr FE 10b, the DSContDistPushCli FE 10c, and/or the DSContDistLog FE 10f may be omitted.

The DSContDistPolicyMgmt FE 10a is an FE configured to manage a policy related to content distribution, and functions to generate a content distribution plan and transfer the content distribution plan to terminals. The DSContDistPolicyMgmt FE 10a may function to configure an overlay network for specific content (S10 of FIG. 2), to set up the content distribution plan of the specific content (S12 of FIG. 2), and to notify terminals, included in the overlay network, of the content distribution plan (S16 of FIG. 2).

The DSContTrackerSvr FE 10d may function to manage an overlay network if content needs to be distributed using P2P. In P2P, the DSContTrackerSvr FE 10d may include the common functions of a tracker server. The DSContTrackerSvr FE 10d may function to generate a list of terminals (S14 of FIG. 2) and to receive requests from terminals within the list of terminals and send the list of terminals to the terminal (S18 of FIG. 2).

The DSContDistPeer FE 10e may function as a peer of an overlay network if content needs to be distributed using P2P. In general, the DSContDistPeer FE 10e may have the common function of a P2P peer. The contents server 10, together with terminals, may function as a peer in an overlay network via the DSContDistPeer FE 10e. The DSContDistPeer FE 10e may function to exchange held content information related to specific content (S20 of FIG. 2), and may send all or part of specific content (S22 of FIG. 2).

The DSContDistLog FE 10f may be FE configured to record log information related to content distribution. The DSContDistLog FE 10f may collect content reception results received from terminals. The DSContDistLog FE 10f may record and store the reception results. The content reception results may have a form of the above-described reception completion message. The reception completion message may include the above-described contents. The DSContDistLog FE 10f may send a reception completion acknowledgement message to a terminal that has sent a reception completion message. That is, the DSContDistLog FE 10f may function to receive a reception completion message (S60 of FIG. 10), record the reception completion message (S62 of FIG. 10) and send the reception completion acknowledgement message (S64 of FIG. 10) in the description of the above-described operation.

The DSContDistPullSvr FE 10b enables the contents server 10 to maintain a network server function (e.g., an FTP server and an HTTP server) so that content may be distributed to terminals. If a terminal has not received content using a P2P method by a transmission deadline (or the secondary transmission deadline) as described above, the terminal may access the DSContDistPullSvr FE 10b, and may directly receive the content from the DSContDistPullSvr FE 10b. In this case, the terminal may access the DSContDistPullSvr FE 10b according to a received distribution plan. The DSContDistPullSvr FE 10b may send content using the above-described pull method. The DSContDistPullSvr FE 10b may be included in the above-described alternative content server function unit.

The DSContDistPushCli FE 10c may be a server configured to use a push-type delivery method when the contents server 10 distributes content over terminals. The DSContDistPushCli FE 10c is an FE configured to push content to predetermined terminals, and may use a method of uploading the content to the terminals. When a digital signage service provider attempts to send content to a terminal in a push form, a server for receiving files may be operated within the terminal. The DSContDistPushCli FE 10c may be used when a server (i.e., the DSContDistPushCli FE) on the service provider side uses a method of directly transferring a file to a client (or a terminal). For example, the FTP client of the contents server may access an FTP server being driven in each terminal, and may upload content to the terminal. If a terminal has not received content using a P2P method by a transmission deadline (or the secondary transmission deadline), the terminal may obtain the content via the DSContDistPushCli FE 10c. In this case, the terminal may access the DSContDistPushCli FE 10c according to a received distribution plan. The DSContDistPushCli FE 10c may send the content using a push method. The DSContDistPushCli FE 10c may be included in the alternative server function unit.

In an embodiment of the present invention, the contents server 10 may further include a warning message transmission/reception unit or a network speed information transmission/reception unit or both. The warning message transmission/reception unit or the network speed information transmission/reception unit or both may be omitted.

The warning message transmission/reception unit (not shown) of the contents server 10 may receive a warning message transmitted by a terminal. Unlike the warning message transmission/reception unit of a terminal, the warning message transmission/reception unit of the contents server 10 may not send a warning message to a terminal until the warning message is received from the terminal. In some embodiments, the warning message transmission/reception unit of the contents server 10 may send a warning message, received from a terminal, to all terminals within an overlay network for specific content. The warning message transmission/reception unit of the contents server 10 may send a warning, having a form different from the warning message, to all terminals managed by the contents server according to a designer's intention. The warning message transmission/reception unit of the contents server 10 may function to receive the above-described warning message (S30 of FIG. 6). As described above, the warning message transmission/reception unit of the contents server 10 may also send a warning acknowledgement message according to a designer's intention. As described above, such operations may be performed if specific content has not been received by the primary transmission deadline or if another transmission deadline elapses. Alternatively, the operations may be performed regardless of a transmission deadline. The warning message transmission/reception unit of the contents server 10 may be included in the DSContDistPeer FE 10e or the DSContTrackerSvr FE 10d. Accordingly, the DSContDistPeer FE 10e or the DSContTrackerSvr FE 10d may function as the warning message transmission/reception unit.

The network speed information transmission/reception unit (not shown) of the contents server 10 may receive network speed information from respective terminals. Furthermore, the network speed information transmission/reception unit of the contents server 10 may send the network speed information to a specific terminal. In some embodiments, the network speed information transmission/reception unit of the contents server 10 may send the network speed information of terminals to a terminal to which the transmission of specific content has not been completed by a specific transmission deadline. In another embodiment, the network speed information transmission/reception unit of the contents server 10 may send the network speed information of terminals regardless of a transmission deadline. As described above, when network speed information is sent, the network speed information transmission/reception unit of the contents server 10 may analyze network average speed information and send the network average speed analysis information. The network speed information transmission/reception unit of the contents server 10 may function to receive the above-described network average speed information about at step S50, and may transfer the above-described pieces of network average speed information of all terminals at step S52. In some embodiments, the network speed information transmission/reception unit of the contents server 10 may be included in the DSContDistPeer FE 10e, the DSContDistPolicyMgmt FE 10a or the DSContTrackerSvr FE 10d. Accordingly, the DSContDistPeer FE 10e, the DSContDistPolicyMgmt FE 10a or the DSContTrackerSvr FE 10d may function as the network speed information transmission/reception unit.

In some embodiments, the contents server 10 may further include other modules.

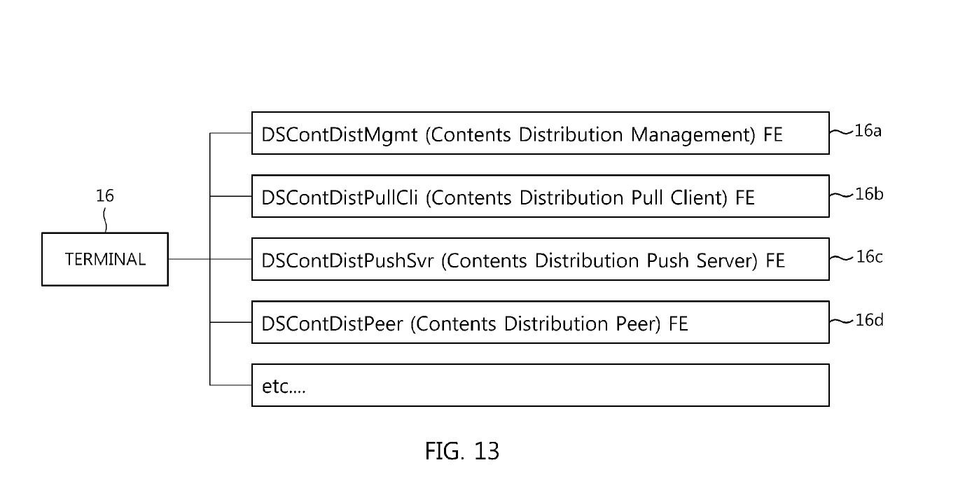

FIG. 13 is a diagram illustrating an embodiment of the terminal according to an embodiment of the present invention.

The terminal 16 according to an embodiment of the present invention may correspond to each digital display on digital signage. The terminal 16 according to an embodiment of the present invention may be a peer over a P2P network. In FIG. 13, the terminal has been assigned a reference number 16, and a terminal denoted by another reference numeral may be considered to be the same as the terminal 16 of FIG. 13.

The terminal 16 is described below based on its modules. Each of the modules may be placed within the terminal, or may be present outside the terminal.

The terminal 16 according to an embodiment of the present invention may include a content distribution management (DSContDistMgmt) FE 16a, content distribution pull client (DSContDistPullCli) FE 16b, a content distribution push server (DSContDistpushSvr) FE 16c and/or a content distribution peer (DSContDistpeer) FE 16d.

The DSContDistPullCli FE 16b or the DSContDistPushSvr FE 16c may be omitted.

The DSContDistMgmt FE 16a may receive a content distribution plan from the DSContDistPolicyMgmt of a service provider (the contents server or an FE of the contents server). The DSContDistMgmt FE 16a may function to manage other FEs within the terminal so that content may be received according to a content distribution plan. The DSContDistMgmt FE 16a may function to receive a content distribution plan (S16 of FIG. 2).

The DSContDistPeer FE 16d may receive and distribute content using a P2P method. The DSContDistPeer FE 16d may receive content from the DSContDistPeer FE 10e of the contents server 10 or the DSContDistPeer FE 16d of another terminal. Furthermore, the DSContDistPeer FE 16d may distribute content to the DSContDistPeer FEs 16d of other terminals. Accordingly, the terminal 16 may function as a peer of an overlay network. In general, the DSContDistPeer FE 16d may have the common functions of a P2P peer. The DSContDistPeer FE 16d may function to exchange the pieces of held content information for specific content (S20 of FIG. 2) and request and send all or part of specific content (S22 of FIG. 2).

Furthermore, the DSContDistPeer FE 16d may request and receive a list of terminals (S18 of FIG. 2). The DSContDistPeer FE 16d may receive a list of terminals, included in an overlay network, from the contents server 10 or another terminal, or may receive a list of terminals managed by the tracker server function unit of the contents server 10.

Furthermore, the DSContDistPeer FE 16d may exchange held content information for specific content with a terminal that belongs to all terminals that have received a warning message and that has all or part of specific content (S34 of FIG. 6), and may receive all or part of specific content based on the received held content information (S36 of FIG. 6). Such an operation may be set as an “operation that is performed when content is not received” after the primary transmission deadline as described above. Furthermore, the DSContDistPeer FE 16d may exchange held content information for specific content with a terminal that has send a warning message (S34 of FIG. 6), and may send all or part of specific content to the terminal when the terminal requests all or part of specific content (S36 of FIG. 6).

Furthermore, when pieces of information about network average speeds are received, the DSContDistPeer FE 16d may exchange all or part of content with a terminal that belongs to terminals having all or part of content and that has the fastest network average speed (S54 of FIG. 8).

Furthermore, the DSContDistPeer FE 16d may preferentially receive another piece of content if another piece of content has higher priority based on information about the priority of specific content.

Furthermore, if the reception of specific content has been completed, the DSContDistPeer FE 16d may function to send a reception completion message to the contents server 10 (or the DSContDistLog FE of the contents server) (S60 of FIG. 10), and may receive a reception completion acknowledgement message, indicative that the reception completion message has been received, from the contents server 10 (S64 of FIG. 10).

Furthermore, the DSContDistPeer FE 16d may function to repeatedly exchange held content information with the contents server 10 (or the DSContDistPeer FE of the contents server) or another terminal (or the DSContDistPeer FE of another terminal) a predetermined number of times at predetermined time intervals until a reception completion acknowledgement message is received (S20 of FIG. 2), and may function to request and receive or send content (S22 of FIG. 2). In this case, the predetermined time intervals and the predetermined number of times may be included in the above-described content distribution plan.

The DSContDistPullCli FE 16b may function to access the contents server 10 of a digital signage service provider (or the DSContDistPullSvr FE of the contents server) and request and receive content. Such an operation may be performed according to the above-described content distribution plan. The DSContDistPullCli FE 16b may receive content using a pull method. If the reception of content has not been completed using a P2P method by a transmission deadline (or the secondary transmission deadline), the DSContDistPullCli FE 16b may access the contents server 10 (or the DSContDistPullSvr FE of the contents server) and receive the content.

The DSContDistPushSvr FE 16c may be prepared to receive content from the contents server of a digital signage service provider (or the DSContDistPushCli FE of the contents server) irregularly/asynchronously. For example, an FTP server, an HTTP server or an FTP server may correspond to the DSContDistPushSvr FE 16c. For security purposes, the DSContDistPushSvr FE 16c may use a secure channel (e.g., SFTP or HTTPS), or may authenticate a user using an ID/password. The DSContDistPushSvr FE 16c may obtain content using a push method. The DSContDistPushSvr FE 16c may access the contents server 10 (or the DSContDistPushCli FE of the contents server) according to a received distribution plan. The contents server 10 (or the DSContDistPushCli FE of the content server) may use a method of uploading content to the DSContDistPushSvr FE 16c of the terminal 16. If the reception of content has not been completed using a P2P method by a transmission deadline (or the secondary transmission deadline), the content may be obtained via the DSContDistPushSvr FE 16c.

The terminal 16 may further include the warning message transmission/reception unit, the network speed information transmission/reception unit and/or an inter-terminal network interface. The warning message transmission/reception unit, the network speed information transmission/reception unit and/or the inter-terminal network interface may be omitted.

The warning message transmission/reception unit (not shown) of the terminal 16 may send a warning message to content. The warning message transmission/reception unit of the terminal 16 may send a warning message, received from another terminal, to all terminals within an overlay network for specific content. The warning message transmission/reception unit of the terminal 16 may report a warning, having a form different from the warning message, to the contents server 10 or other terminals according to a designer's intention. The warning message transmission/reception unit of the terminal 16 may function to send a warning message (S30 of FIG. 6). The warning message transmission/reception unit of the terminal 16 may send a warning acknowledgement message to a terminal that has sent a warning message. The warning acknowledgement message may mean that the warning message has been received. Such operations may be performed when specific content is not received by the primary transmission deadline. Alternatively, the operations may be performed after another transmission deadline. Alternatively, the operations may be performed regardless of a transmission deadline. The warning message transmission/reception unit of the terminal 16 may be included in the DSContDistPeer FE 16d. Accordingly, the DSContDistPeer FE 16d may function as the warning message transmission/reception unit.

The network speed information transmission/reception unit (not shown) of the terminal 16 may send the network speed information of a current terminal to the contents server 10 (or the network speed information transmission/reception unit, DSContTrackerSvr FE or DSContDistPeer FE of the contents server) (S50 of FIG. 8). The network speed information transmission/reception unit of the terminal 16 may send network speed information to the contents server 10 if specific content has not been received by a specific transmission deadline. In some embodiments, the network speed information transmission/reception unit of the terminal 16 may send network speed information regardless of a transmission deadline. The network speed information transmission/reception unit of the terminal 16 may receive pieces of network average speed information of all terminals from the contents server 10 (S52 of FIG. 8). The pieces of received network average speed information of all the terminals may be analyzed network average speed information. The network speed information transmission/reception unit of the terminal 16 may be included in the DSContDistPeer FE 16d or the DSContDistMgmt FE 16a. Accordingly, the DSContDistPeer FE 16d or the DSContDistMgmt FE 16a may function as the network speed information transmission/reception unit.

The inter-terminal network interface (not shown) of the terminal 16 may function to transfer a received content distribution plan or a received list of terminals to the terminals within the list of terminals. Furthermore, the inter-terminal network interface of the terminal 16 may receive a content distribution plan or a list of terminals from another terminal (or the inter-terminal network interface of another terminal). The inter-terminal network interface of the terminal 16 may be included in the DSContDistPeer FE 16d or the DSContDistMgmt FE 16a. Accordingly, the DSContDistPeer FE 16d or the DSContDistMgmt FE 16a may function as the inter-terminal network interface.

In some embodiments, the terminal 16 may further include other modules.

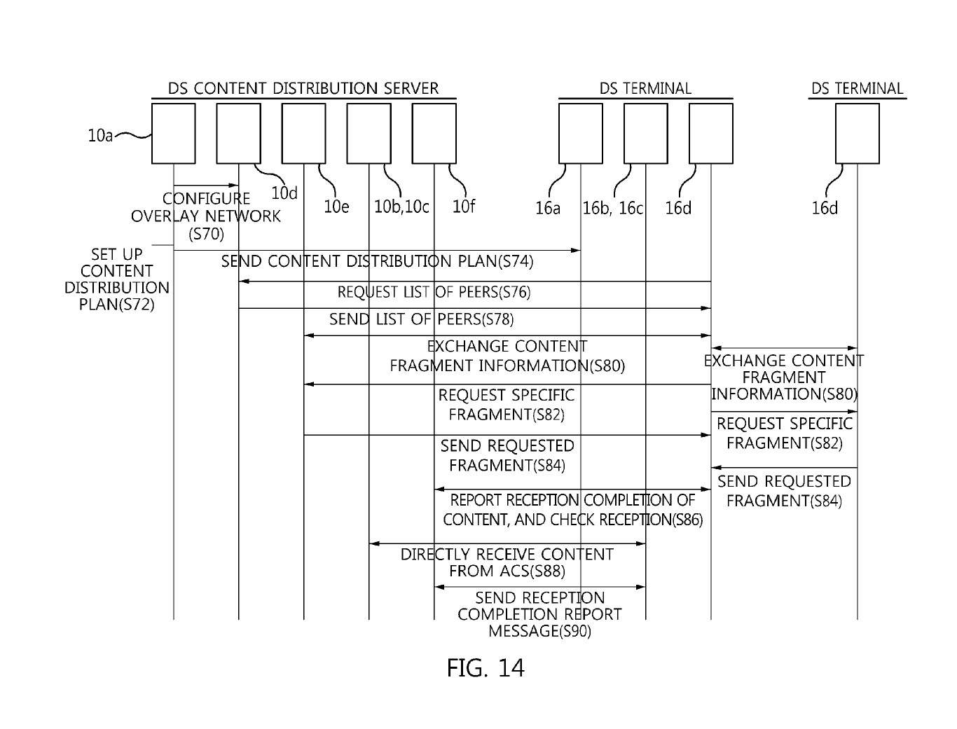

FIG. 14 is a diagram illustrating an embodiment of a method of sending and receiving content according to an embodiment of the present invention. FIG. 14 illustrates the overall operation between the contents server and terminals step by step. The steps indicate modules within the contents server and the terminal. In FIG. 14, a “DS content distribution server” may indicate the contents server, and a “DS terminal” may indicate the terminal.

The method of sending and receiving content according to an embodiment of the present invention may include configuring an overlay network S70, setting up a content distribution plan at step S72, providing notification of the content distribution plan at step S74, requesting a list of peers at step S76, sending the list of peers at step S78, exchanging the pieces of content fragment information at step S80, requesting a specific fragment at step S82, sending the requested fragment at step S84, reporting the reception of content and checking reception at step S86, directly receiving content from an ACS at step S88, and/or sending a reception completion report message at step S90.

First, configuring the overlay network S70 may be the same as configuring the overlay network (S10 of FIG. 2). The DSContPolicyMgmt FE 10a of the contents server 10 may configure the overlay network, and the DSContTrackerSvr FE 10d of the contents server 10 may manage the overlay network.

Setting up the content distribution plan at step S72 may be the same as setting up the content distribution plan (S12 of FIG. 2). The DSContPolicyMgmt FE 10a of the contents server 10 may set up the content distribution plan.

Providing the notification of the content distribution plan at step S74 may be the same as providing the notification of the content distribution plan (S16 of FIG. 2). The DSContPolicyMgmt FE 10a of the contents server 10 may notify the DSContDistMgmt 16a of the terminal 16 of the content distribution plan.

Requesting the list of peers at step S76 and sending the list of peers at step S78 may be the same as request and receiving the list of terminals (S18 of FIG. 2). The list of peers may be the same as the list of terminals. Prior to a request for the list of peers, the DSContTrackerSvr FE 10d of the contents server 10 may perform generating the list of terminals (S14 of FIG. 2). The DSContDistPeer FE 16d of the terminal may request the list of peers from the DSContTrackerSvr FE 10d of the contents server, and the DSContTrackerSvr FE 10d of the contents server may send the list of peers to the DSContDistPeer FE 16d of the terminal.

Exchanging the pieces of content fragment information at step S80 may be the same as exchanging the pieces of held content information (S20 of FIG. 2). Exchanging the pieces of content fragment information may be performed between the DSContDistPeer FE 10e of the contents server 10 and the DSContDistPeer FE 16d of the terminal 16. The content fragment may be a fragment logically obtained from content. The content fragment information may be held content information.

Requesting the specific fragment at step S82 and sending the requested fragment at step S84 may be the same as requesting and receiving some of the overall content (S22 of FIG. 2). Requesting and sending the specific fragment may be performed between the DSContDistPeer FE 10e of the contents server 10 and the DSContDistPeer FE 16d of the terminal 16. The specific fragment may be all or part of content.

Reporting the reception of content and checking reception at step S86 may be considered to include all of sending the reception completion message (S60 of FIG. 10), recording the reception completion message (S62 of FIG. 10) and sending the reception completion acknowledgement message (S64 of FIG. 10). If the reception of the specific content has been completed using a P2P method, the DSContDistPeer FE 16d of the terminal 16 may send the reception completion message to the DSContDistLog FE 10f of the contents server 10, the DSContDistLog FE 10f of the contents server 10 may record the reception completion message, and the DSContDistLog FE 10f of the contents server 10 may send the reception completion acknowledgement message to the DSContDistPeer FE 16d of the terminal 16.

Directly receiving the content from the ACS at step S88 may be the same as directly receiving the content from the above-described alternative content server function unit or uploading, by the alternative content server function unit, the content on to the terminal 16 (S40 of FIG. 7). The DSContDistPullCli FE 16b of the terminal 16 may access the DSContPullSvr FE 10b of the contents server 10 and receive the content using the pull method. Alternatively, the DSContPushCli FE 10c of the contents server 10 may upload the content to the DSContPushSvr FE 16c of the terminal 16. In this case, the ACS is an Alternative Contents Server, and may be the alternative server function unit. The ACS may include the DSContPullSvr FE 10b or the DSContPushCli FE 10c of the contents server 10.

Sending the reception completion report message at step S90 may be considered to include all of sending the reception completion message (S60 of FIG. 10), recording the reception completion message (S62 of FIG. 10) and sending the reception completion acknowledgement message (S64 of FIG. 10). If the reception of content has not been completed by a deadline using a P2P method, the DSContPullCli FE 16b of the terminal 16 may send a reception completion message to the DSContPullSvr FE 10b of the contents server 10, and the DSContPullSvr FE 10b of the contents server 10 may send a reception completion acknowledgement message to the DSContPullCli FE 16b of the terminal 16. Furthermore, if the reception of content has not been completed by a deadline using a P2P method, the DSContPushSvr FE 16c of the terminal 16 may send a reception completion message the DSContPushCli FE 10c of the contents server 10, and the DSContPushCli FE 10c of the contents server 10 may send a reception completion acknowledgement message to the DSContPushSvr FE 16c of the terminal 16. The DSContPushCli FE 10c of the contents server 10 may record the received reception completion message. Alternatively, the DSContPushCli FE 10c of the contents server 10 may send the reception completion message to the DSContDistLog FE 10f of the contents server 10 so that the reception completion message is recorded.

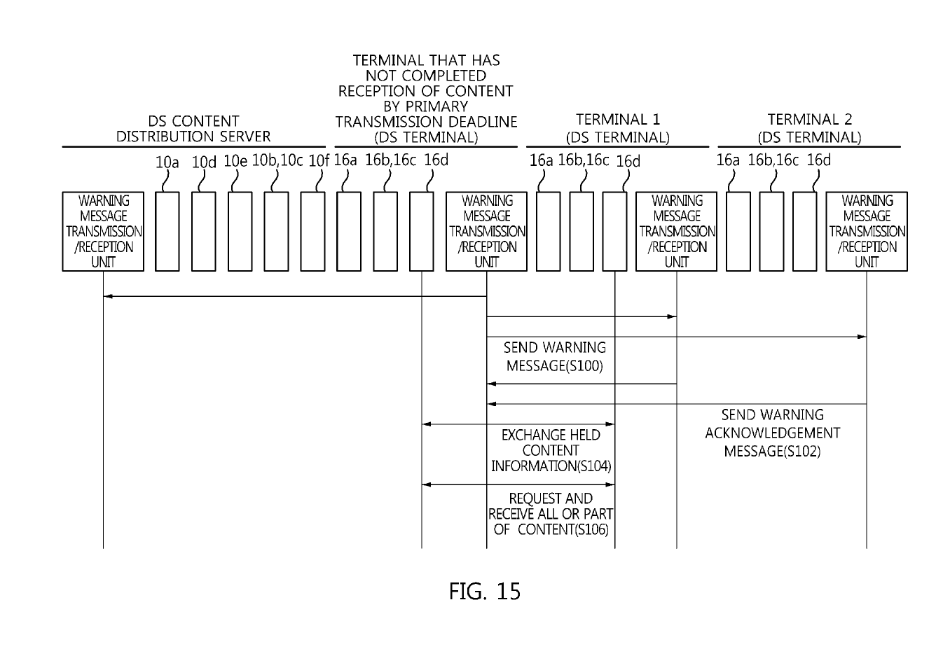

FIG. 15 is a diagram illustrating an operation when the reception of specific content is not completed by the primary transmission deadline of FIG. 14 via the modules of the contents server and the terminal.

The operation when the reception of specific content is not completed by the primary transmission deadline may include sending a warning message at step S100, sending a warning acknowledgement message at step S102, exchanging pieces of held content information at step S104, and/or requesting and receiving all or part of specific content at step S106.

First, sending the warning message at step S100 may be the same as sending the warning message (S30 of FIG. 6). The warning message transmission/reception unit of a terminal by which the reception of the specific content has not been completed by the primary transmission deadline may send the warning message to the warning message transmission/reception unit of the contents server 10 and the warning message transmission/reception unit of other terminals (e.g., the terminal 1 and the terminal 2 of FIG. 15) within the overlay network.

Sending the warning acknowledgement message at step S102 may be the same as sending the warning acknowledgement message (S32 of FIG. 6). The warning message transmission/reception units of terminals (e.g., the terminal 1 and the terminal 2 of FIG. 15) that have received the warning message may send the warning acknowledgement messages to the warning message transmission/reception unit of the terminal that has sent the warning message (i.e., the terminal by which the reception of the specific content has not been completed by the primary transmission deadline).

Exchanging the pieces of held content information at step S104 may be the same as exchanging the pieces of held content information (S34 of FIG. 6). A terminal (e.g., the terminal 1), belonging to terminals (e.g., the terminal 1 and the terminal 2 of FIG. 15) that have received the warning message and having all or part of content, may exchange held content information with the terminal by which the reception of the specific content has not been completed. That is, the DSContDistPeer FE of the terminal 1 may exchange held content information with the DSContDistPeer FE of the terminal by which the reception of the specific content has not been completed.

Requesting and receiving all or part of content at step S106 may be the same as requesting and receiving all or part of content (S36 of FIG. 6). A terminal (e.g., the terminal 1) having all or part of specific content and a terminal by which the reception of the specific content has not been completed may request the specific content from each other, and may distribute and receive the specific content. That is, if a request for all or part of specific content is received from the DSContDistPeer FE of the terminal by which the reception of the specific content has not been completed, the DSContDistPeer FE of the terminal 1 may distribute the specific content and request and receive all or part of specific content.

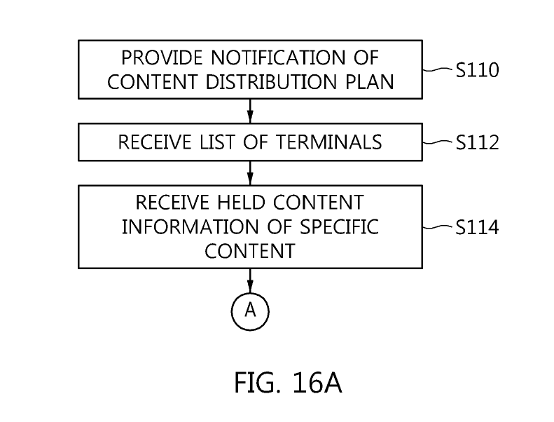

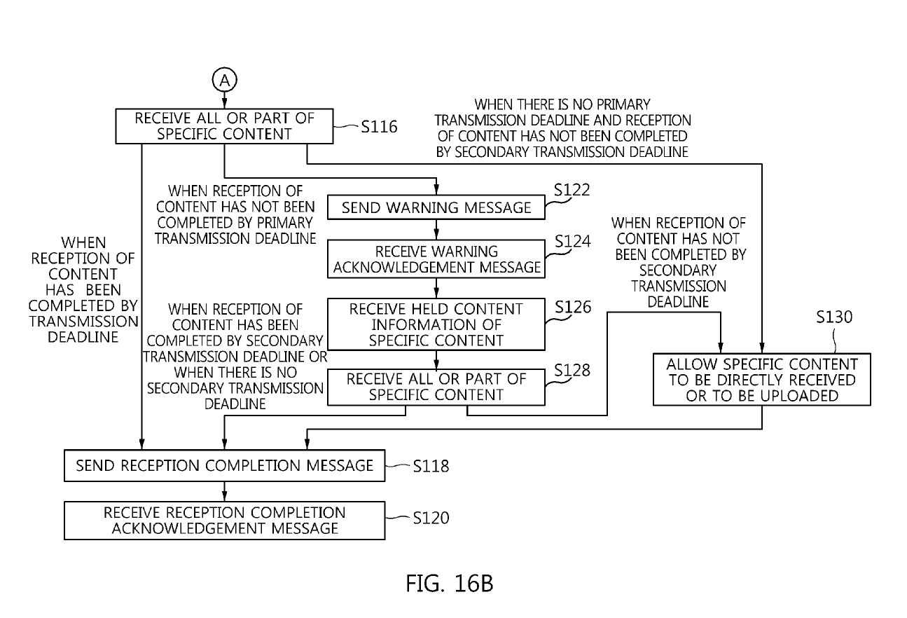

FIGS. 16A and 16B are detailed diagrams illustrating a method of receiving content according to an embodiment of the present invention.

The method of receiving content according to an embodiment of the present invention may include receiving notification of a content distribution plan at step S110, receiving a list of terminals at step S112, receiving held content information of the specific content at step S114, receiving all or part of specific content at step S116, sending a reception completion message at step S118, receiving a reception completion acknowledgement message at step S120, sending a warning message at step S122, receiving a warning acknowledgement message at step S124, receiving held content information of the specific content at step S126, receiving all or part of specific content at step S128, and/or directly receiving the specific content or uploading the specific content at step S130.

In this case, sending the reception completion message at step S118, receiving the reception completion acknowledgement message at step S120, sending the warning message at step S122, receiving the warning acknowledgement message at step S124, receiving held content information of the specific content at step S126, receiving all or part of specific content at step S128, and directly receiving the specific content or uploading the specific content at step S130 may be omitted.

First, receiving notification of the content distribution plan at step S110 may include receiving notification of the content distribution plan by the contents server 10 or another terminal. In this case, the content distribution plan may include information about the ID of the specific content, overlay network ID information for the specific content and the address of a tracker server function unit of the contents server for the overlay network. Receiving notification of the content distribution plan at step S110 may be the same as providing the notification of the content distribution plan (S16 of FIG. 2) from the viewpoint of the terminal.

Receiving the list of terminals at step S112 may include receiving the list of terminals, included in an overlay network identified by overlay network ID information, or the list of terminals, managed by a tracker server function unit identified by the address of the tracker server function unit, from the contents server 10 or another terminal. Receiving the list of terminals at step S112 may be the same as requesting and receiving the list of terminals (S18 of FIG. 2) from the viewpoint of the terminal.

Receiving the held content information of the specific content at step S114 may include receiving held content information, indicating whether or not all or part of specific content is held, from at least one of terminals included in the list of terminals. Receiving the held content information of the specific content at step S114 may be the same as exchanging the pieces of held content information (S20 of FIG. 2) from the viewpoint of the terminal.

Receiving all or part of specific content at step S116 may include receiving all or part of specific content from the at least one terminal that has received the held content information based on the received held content information. Receiving all or part of specific content at step S116 may be the same as requesting and receiving all or part of specific content (S22 of FIG. 2) from the viewpoint of the terminal.

Sending the reception completion message at step S118 may include sending a reception completion message to the contents server 10 if the reception of the specific content has been completed. Sending the reception completion message at step S118 may be performed if the reception of the specific content has been completed using a P2P method by a transmission deadline, if the reception of the specific content has been completed by the secondary transmission deadline although the primary transmission deadline has passed or if the reception of the specific content has been completed using the push or pull method although the secondary transmission deadline has passed when the secondary transmission deadline is not. Sending the reception completion message at step S118 may be the same as sending the reception completion message (S60 of FIG. 10) from the viewpoint of the terminal.

Receiving the reception completion acknowledgement message at step S120 may include receiving the reception completion acknowledgement message indicative that the reception completion message transmitted by the contents server 10 has been received. Receiving the reception completion acknowledgement message at step S120 may be the same as sending the reception completion acknowledgement message (S64 of FIG. 10) from the viewpoint of the terminal.

Sending the warning message at step S122 may be, if the reception of the reception of the specific content has not been completed by the primary transmission deadline, sending the warning message to all terminals within the list of terminals and to the contents server. Sending the warning message at step S122 may be the same as sending the warning message (S30 of FIG. 6) from the viewpoint of the terminal.

Receiving the warning acknowledgement message at step S124 may include receiving the warning acknowledgement message indicative that the warning message has been received from a terminal that belongs to all terminals that have received the warning message and that have all or part of specific content. Receiving the warning acknowledgement message at step S124 may be the same as sending the warning acknowledgement message (S32 of FIG. 6) from the viewpoint of the terminal.

Receiving the held content information of the specific content at step S126 may include receiving the held content information of the specific content from a terminal that belongs to all terminals having received the warning message and that has the overall specific content. Receiving the held content information of the specific content at step S126 may be the same as exchanging the pieces of held content information (S34 of FIG. 6) from the viewpoint of the terminal.

Receiving all or part of specific content at step S128 may include receiving all or part of specific content from at least one of terminals having all or part of specific content based on the received held content information. Receiving all or part of specific content at step S128 may be the same as requesting and receiving all or part of content (S36 of FIG. 6) from the viewpoint of the terminal.

Directly receiving the specific content or uploading the specific content at step S130 may include directly accessing the alternative content server function unit and receiving the specific content or uploading, by the alternative server function unit, the specific content if the reception of the specific content has not been completed by the secondary transmission deadline. Directly receiving the specific content or uploading the specific content at step S130 may be performed if the primary transmission deadline has passed and the reception of the specific content has not been completed by the secondary transmission deadline or if the reception of the specific content has not been completed by the secondary transmission deadline without the primary transmission deadline. Directly receiving the specific content or uploading the specific content at step S130 may be the same as directly receiving the specific content from the alternative content server function unit or uploading, by the alternative content server function unit, the specific content to the terminal (S40 of FIG. 7) from the viewpoint of the terminal.

In an embodiment of the present invention, the content distribution plan may further include a transmission deadline by which the reception of specific content needs to be completed and the address of an alternative server function unit within a corresponding contents server from which the specific content will be received if the reception of the specific content has not been completed by the transmission deadline. The transmission deadline may include at least one of the primary transmission deadline and the secondary transmission deadline.

The method of FIGS. 16A and 16B, although not shown, may further include receiving, by the terminal, a warning message from at least one of terminals within the list of terminals, sending a warning acknowledgement message, indicative that the warning message has been received, to the terminal that has sent the warning message, sending held content information of a current terminal for the specific content to the terminal that has sent the warning message and sending all or part of specific content, possessed by the current terminal, to the terminal that has sent the warning message.

The method of FIGS. 16A and 16B, although not shown, may further include sending, by a terminal, network average speed information at which all or part of specific content is received to the content server, receiving pieces of network average speed information of all terminals within the list of terminals from the contents server and receiving all or part of specific content from a terminal that belongs to the terminals having all or part of specific content and that has the fastest network average speed in the pieces of network average speed information.

Although not illustrated in FIGS. 16A and 16B, the content distribution plan may further include information about the priority of the specific content. Receiving all or part of specific content at step S116 may include receiving all or part of specific content over another piece of content having priority of “middle” or “low” if the specific content has the priority of “high.”

The method of FIGS. 16A and 16B, although not shown, may further include directly accessing, by the terminal, the alternative server function unit and receiving the specific content from the alternative server function unit or directly uploading, by the alternative server function unit, the specific content to a current terminal, if the number of terminals having all or part of specific content is smaller than a predetermined number when the terminal analyzes the received held content information.

The method of FIGS. 16A and 16B, although not shown, may further include repeatedly receiving, by the terminal, held content information and receiving all or part of specific content a predetermined number of times at predetermined time intervals until the reception completion acknowledgement message is received. In this case, the predetermined time intervals and the predetermined number of times may be included in the content distribution plan.

Meanwhile, the reception completion message at step S118 may include at least one of a method of receiving the specific content, the reception start time of the specific content, the reception completion time of the specific content and the network address of a current terminal.

The method of FIGS. 16A and 16B, although not shown, may further include transferring, by the terminal, the content distribution plan or the list of terminals to other terminals within the list of terminals.

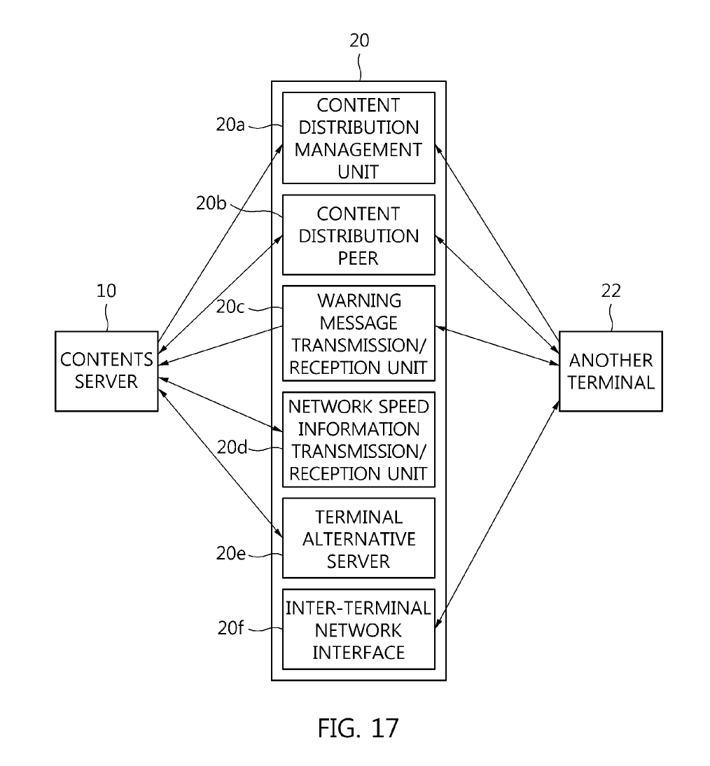

FIG. 17 is a diagram illustrating an embodiment of a digital display terminal that may be remotely controlled according to an embodiment of the present invention.

The digital display terminal 20 that may be remotely controlled according to an embodiment of the present invention may include a content distribution management unit 20a, a content distribution peer 20b, a warning message transmission/reception unit 20c, a network speed information transmission/reception unit 20d, a terminal alternative server 20e, and/or an inter-terminal network interface 20f.

The warning message transmission/reception unit 20c, the network speed information transmission/reception unit 20d, the terminal alternative server 20e, and the inter-terminal network interface 20f may be omitted.

The content distribution management unit 20a may be notified of a content distribution plan by the contents server 10 or another terminal. In this case, the content distribution plan may include information about the ID of specific content, overlay network ID information for the specific content, and the address of a tracker server function unit of the contents server for the overlay network. The content distribution management unit 20a may be the same as the DSContDistMgmt FE 16a of the terminal 16.

The content distribution peer 20b may receive a list of terminals, included in the overlay network identified by overlay network ID information, or a list of terminals, managed by the tracker server function unit identified by the address of the tracker server function unit, from the contents server 10 or another terminal, may receive held content information indicating whether or not all or part of specific content is held from at least one of the terminals included in the list of terminals, and may receive all or part of specific content from a terminal that has sent the held content information based on the held content information. The content distribution peer 20b may be the same as the DSContDistPeer FE 16d of the terminal 16.

The warning message transmission/reception unit 20c may send a warning message to all the terminals included in the list of terminals and the contents server if the reception of the specific content has not been completed by the primary transmission deadline. Furthermore, the warning message transmission/reception unit 20c may receive a warning message from another terminal. Furthermore, the warning message transmission/reception unit 20c may send a warning acknowledgement message, indicative that the warning message has been received, to the terminal that has sent the warning message. The warning message transmission/reception unit 20c may be the same as the warning message transmission/reception unit of the terminal 16.

The network speed information transmission/reception unit 20d may send information about a network average speed at which all or part of specific content is received to the contents server 10, and may receive pieces of network average speed information of all the terminals within the list of the terminal from the contents server 10. The network speed information transmission/reception unit 20d may be the same as the network speed information transmission/reception unit of the terminal 16.

If the reception of the specific content has not been completed by the secondary transmission deadline, the terminal alternative server 20e may directly access the alternative server function unit of the contents server and receive the specific content, or may allow the alternative server function unit of the contents server to directly upload the specific content to the alternative server (or the alternative contents server) of the digital display terminal. The terminal alternative server 20e may include the DSContDistPullCli FE 16b and/or the DSContDistPushSvr FE 16c.

The inter-terminal network interface 20f may transfer a content distribution plan or a list of terminals to other terminals within the list of terminals. The inter-terminal network interface 20f may be the same as the inter-terminal network interface of the terminal.

In the digital display terminal 20 that may be remotely controlled, the content distribution plan may further include a transmission deadline by which the reception of specific content needs to be completed, and the address of an alternative server function unit within a corresponding contents server from which the specific content will be received if the reception of the specific content has not been completed by the transmission deadline. In this case, the transmission deadline may include at least one of the primary transmission deadline and the secondary transmission deadline.

If the reception of the specific content has not been completed by the primary transmission deadline, the warning message transmission/reception unit 20c may send a warning message to all the terminals included in the list of terminals and the contents server, and may receive a warning acknowledgement message, indicative that the warning message has been received, from a terminal that belongs to all terminals that have received the warning message and has all or part of specific content. The content distribution peer 20b may receive the held content information of the specific content from at least one of terminals that have sent the warning acknowledgement messages, and may receive all or part of specific content from the at least one terminal based on the received held content information.

The warning message transmission/reception unit 20c may receive a warning message from one of the terminals included in the list of terminals, and may send a warning acknowledgement message, indicative that the warning message has been received, to the terminal that has sent the warning message. In this case, the content distribution peer 20b may send the held content information of a current terminal for the specific content to the terminal that has sent the warning message, and may send all or part of specific content, possessed by the current terminal, to the terminal that has sent the warning message.

The network speed information transmission/reception unit 20d may send network average speed information at which all or part of specific content information is received to the contents server 10, and may receive pieces of network average speed information of all the terminals within the list of terminals from the contents server 10. In this case, the content distribution peer 20b may receive all or part of specific content from a terminal that belongs to terminals having all or part of specific content and that has the fastest network average speed indicate by the pieces of network average speed information.

The content distribution plan notified to the content distribution management unit 20a may further include information about the priority of the specific content. In this case, the content distribution peer 20b may receive all or part of specific content over another piece of content having priority of “middle” or “low” if the specific content has priority of “high.”

The terminal alternative server 20e may directly access the alternative server function unit of the contents server and receive the specific content from the alternative server function unit, or may allow the alternative server function unit to directly upload the specific content to the terminal alternative server 20e, if the number of terminals having all or part of specific content is smaller than a predetermined number when the terminal alternative server 20e analyzes the received held content information.

If the reception of the specific content has been completed, the content distribution peer 20b may send a reception completion message to the contents server 10, and may receive a reception completion acknowledgement message, indicative that the reception completion message has been received, from the contents server 10.

The content distribution peer 20b may repeat the operation of receiving held content information a predetermined number of times and the operation of receiving all or part of specific content at predetermined time intervals until the reception completion acknowledgement message is received. In this case, the predetermined time intervals and the predetermined number of times may be included in the content distribution plan.

The reception completion message may include at least one of a method of receiving the specific content, the reception start time of the specific content, the reception completion time of the specific content and the network address of the digital display terminal.

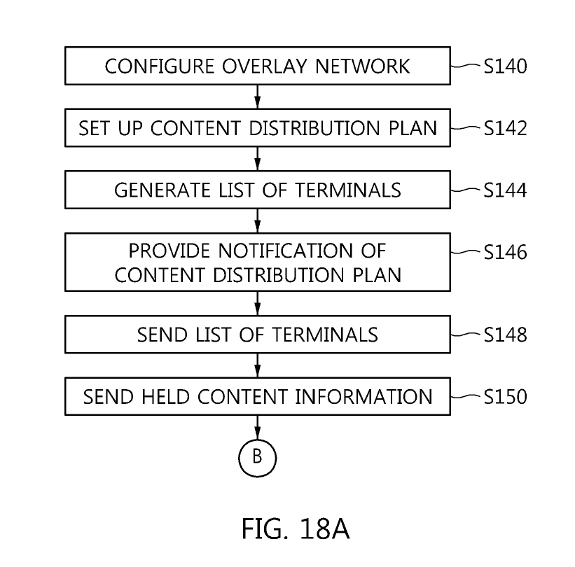

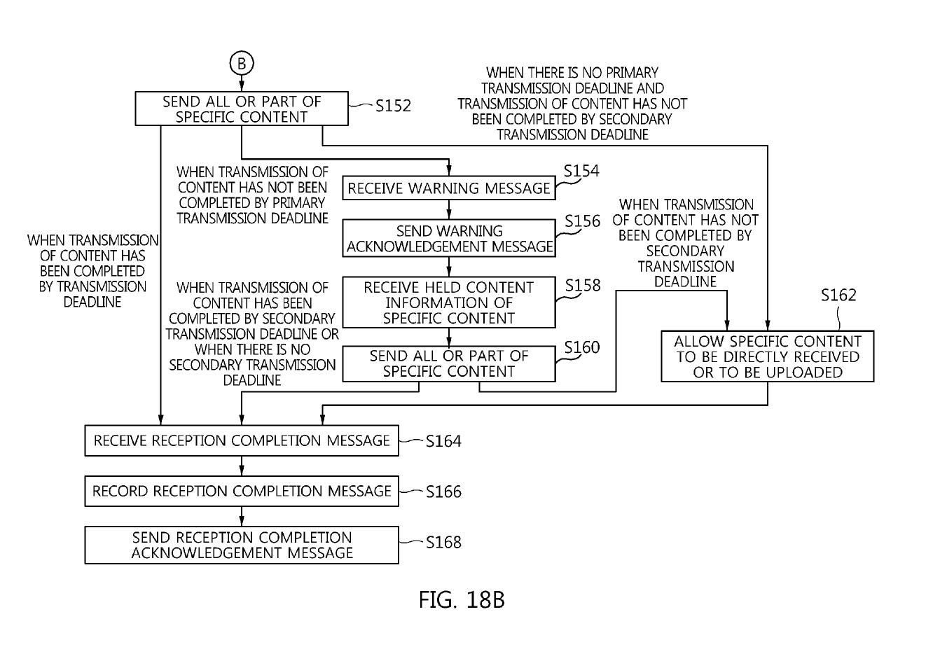

FIGS. 18A and 18B are detailed diagrams illustrating a method of sending content according to an embodiment of the present invention.

The method of sending content according to an embodiment of the present invention may include configuring an overlay network at step S140, setting up a content distribution plan at step S142, generating a list of terminals at step S144, providing notification of the content distribution plan at step S146, sending the list of terminals at step S148, sending held content information at step S150, sending all or part of specific content at step S152, receiving a warning message at step S154, sending a warning acknowledgement message at step S156, receiving held content information for the specific content at step S158, sending all or part of specific content at step S160, allowing the specific content to be directly received or to be uploaded at step S162, receiving a reception completion message at step S164, recording the reception completion message at step S166, and/or sending a reception completion acknowledgement message at step S168.

In this case, receiving the warning message S154, sending the warning acknowledgement message at step S156, receiving held content information of the specific content at step S158, sending all or part of specific content at step S160, allowing the specific content to be directly received or upload the specific content at step S162, receiving the reception completion message at step S164, recording the reception completion message at step S166, and sending the reception completion acknowledgement message at step S168 may be omitted.

First, at step S140 of configuring the overlay network, the contents server 10 may configure the overlay network for the specific content. Configuring the overlay network at step S140 may be the same as configuring the overlay network (S10 of FIG. 2).

Setting up the content distribution plan at step S142 may include setting up the content distribution plan of the specific content over the overlay network configured in configuring the overlay network at step S140. In this case, the content distribution plan may include information about the ID of the specific content, overlay network ID information for the specific content and the address of a tracker server function unit of the contents server for the overlay network. Setting up the content distribution plan at step S142 may be the same as generating the content distribution plan (S12 of FIG. 2).

Generating the list of terminals at step S144 may include generating a list of terminals, included in the overlay network identified by the overlay network ID information included in the content distribution plan, or a list of terminals, managed by the tracker server function unit identified by the address of the tracker server function unit included in the content distribution plan. Generating the list of terminals at step S144 may be the same as the list of terminals (S14 of FIG. 2).

Providing the notification of the content distribution plan at step S146 may include notifying the at least one terminal of the terminals, included in the list of terminals generated in generating the list of terminals at step S144, of the content distribution. Providing the notification of the content distribution plan at step S146 may be the same as providing the notification of the content distribution plan (S16 of FIG. 2) from the viewpoint of the contents server 10.

Sending the list of terminals at step S148 may includes sending the list of terminals to at least one of the terminals included in the list of terminals. Sending the list of terminals at step S148 may be the same as sending the list of terminals to a terminal in response to a request from the terminal at step S18 (of FIG. 2) of requesting and receiving the list of terminals.

Sending the held content information at step S150 may include sending the held content information, indicating whether or not the specific content is held, to at least one of the terminals included in the list of terminals. Sending the held content information at step S150 may be the same as exchanging the pieces of held content information (S20 of FIG. 2) from the viewpoint of the contents server 10.

Sending all or part of specific content at step S152 may include sending all or part of specific content to the terminal that has sent the held content information in sending the held content information at step S150. Sending all or part of specific content at step S152 may be the same as requesting and receiving all or part of specific content (S22 of FIG. 2) from the viewpoint of the contents server 10.

Receiving the warning message S154 may include receiving the warning message from a terminal to which the transmission of the specific content has not been completed by the primary transmission deadline. Receiving the warning message at step S154 may be the same as sending the warning message (S30 of FIG. 6) from the viewpoint of the contents server 10.

Sending the warning acknowledgement message at step S156 may include sending the warning acknowledgement message, indicative that the warning message has been received, to the terminal to which the transmission of the specific content has not been completed at step S30 (of FIG. 6) of sending the warning message. Sending the warning acknowledgement message at step S156 may be the same as sending the warning acknowledgement message (S32 of FIG. 6) from the viewpoint of the contents server 10.

Receiving the held content information of the specific content at step S158 may include receiving the held content information of a terminal to which the transmission of the specific content has not been completed from the terminal to which the transmission of the specific content has not been completed in sending the warning message (S30 of FIG. 6). Receiving the held content information of the specific content at step S158 may be the same as exchanging the pieces of held content information (S34 of FIG. 6) from the viewpoint of the contents server 10.

Sending all or part of specific content at step S160 may include sending all or part of specific content to the terminal to which the transmission of the specific content has not been completed based on the held content information received in receiving held content information of the specific content at step S158. Sending all or part of specific content at step S160 may be the same as requesting and receiving all or part of content (S36 of FIG. 6) from the viewpoint of the contents server 10.

Allowing the specific content to be directly received or to be uploaded at step S162 may include allowing the terminal to which the transmission of the specific content has not been completed to directly access the alternative server function unit of the contents server and to receive the specific content, or may include, if the transmission of the specific content has not been completed by the secondary transmission deadline, directly uploading, by the alternative server function unit, the specific content to the terminal to which the transmission of the specific content has not been completed. Allowing the specific content to be directly received or to be uploaded at step S162 may be the same as directly receiving the specific content from the alternative server function unit or uploading, by the alternative server function unit, the specific content to the terminal (S40 of FIG. 7) from the viewpoint of the contents server 10.

Receiving the reception completion message at step S164 may include, if the transmission of the specific content is completed, receiving the reception completion message from the terminal to which the transmission of the specific content has been completed. Receiving the reception completion message at step S164 may be the same as sending the reception completion message (S60 of FIG. 10) from the viewpoint of the contents server 10.

Recording the reception completion message at step S166 may include recording the reception completion message, received in receiving the reception completion message at step S164, on the contents server 10. Recording the reception completion message at step S166 may be the same as recording the reception completion message (S62 of FIG. 10) from the viewpoint of the contents server 10.

Sending the reception completion acknowledgement message at step S168 may include sending the reception completion acknowledgement message, indicative that the reception completion message has been received, to the terminal to which the transmission of the specific content has been completed. Sending the reception completion acknowledgement message at step S168 may be the same as sending the reception completion acknowledgement message (S64 of FIG. 10) from the viewpoint of the contents server 10.

The content distribution plan may further include a transmission deadline by which the transmission of the specific content needs to be completed, and the address of an alternative server function unit of the contents server from which the specific content will be received if the transmission of the specific content has not been completed by the transmission deadline. In this case, the transmission deadline may include at least one of the primary transmission deadline and the secondary transmission deadline.

Furthermore, pieces of network average speed information at which all or part of specific content is received may be received from all terminals within a list of terminals, and the pieces of received network average speed information of all the terminals may be transferred to at least one of the terminals within the list of terminals.

Furthermore, all or part of specific content is transmitted, and the content distribution plan may further include information about the priority of the specific content. In this case, if the specific content has priority of “high,” all or part of specific content may be transmitted over another piece of content having priority of “middle” or “low.”

Furthermore, if the number of terminals having all or part of specific content in an overlay network for the specific content is smaller than a predetermined number, at least one of terminals within the overlay network may be allowed to directly access the alternative server function unit of the contents server and to receive the specific content, or the alternative server function unit may be allowed to directly upload the specific content to the at least one terminal.

Furthermore, the reception completion message may include at least one of a method of receiving the specific content, the reception start time of the specific content, the reception completion time of the specific content and the network address of a terminal by which the reception of the specific content has been completed.

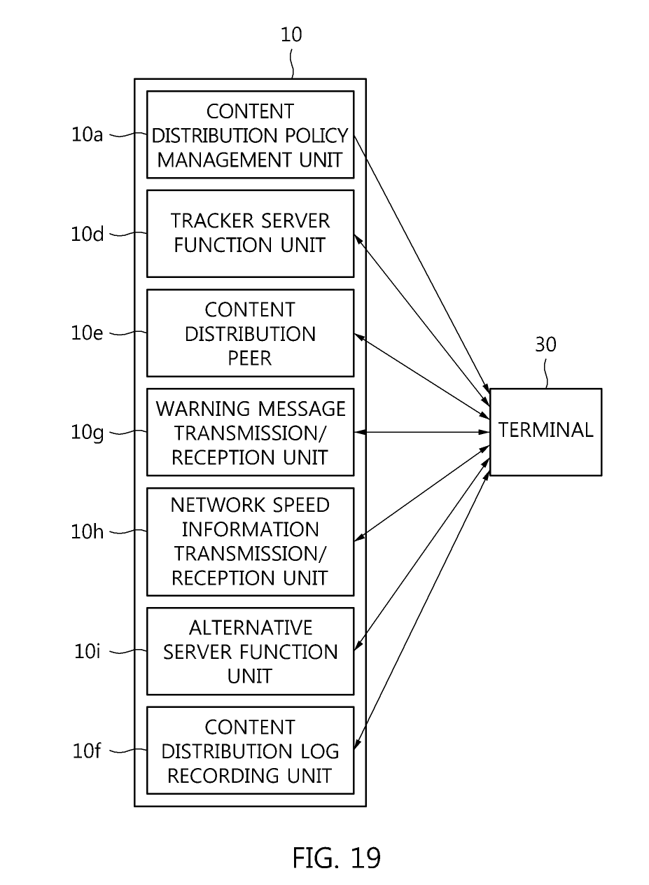

FIG. 19 is a diagram illustrating an embodiment of a contents server according to an embodiment of the present invention.

The contents server 10 according to an embodiment of the present invention may include a content distribution policy management unit 10a, a tracker server function unit 10d, a content distribution peer 10e, a warning message transmission/reception unit 10g, a network speed information transmission/reception unit 10h, an alternative server function unit 10i, and/or a content distribution log recording unit 10f.

The warning message transmission/reception unit 10g, the network speed information transmission/reception unit 10h, the alternative server function unit 10i and the content distribution log recording unit 10f may be omitted.

The content distribution policy management unit 10a may configure an overlay network for specific content, may set up the content distribution plan of the specific content, and may notify at least one of terminals, included in the configured overlay network, of the generated content distribution plan. The content distribution policy management unit 10a may be the same as the DSContDistPolicyMgmt FE of the contents server.

The tracker server function unit 10d may generate a list of terminals and send the list of terminals to at least one of the terminals within the list of terminals. In this case, the content distribution plan set up by the content distribution policy management unit 10a includes information about the ID of specific content, overlay network ID information for the specific content and the network address of the tracker server function unit 10d. In this case, the list of terminals may be a list of terminals included in the overlay network identified by the overlay network ID information, or may be a list of terminals managed by the tracker server function unit 10d identified by the network address of the tracker server function unit 10d. The tracker server function unit 10d may be the same as the DSContTrackerSvr FE of the contents server.

The content distribution peer 10e may send held content information, indicating whether or not the specific content is held, to at least one of the terminals included in the list of terminals, and may send all or part of specific content to a terminal that has sent held content information. The content distribution peer 10e may be the same as the DSContDistPeer FE of the contents server.

The warning message transmission/reception unit 10g may receive a warning message from a terminal to which the transmission of the specific content has not been completed by the primary transmission deadline, and may send a warning acknowledgement message, indicative that the warning message has been received, to the terminal to which the transmission of the specific content has not been completed. The warning message transmission/reception unit 10g may be the same as the warning message transmission/reception unit of the contents server.

The network speed information transmission/reception unit 10h may receive pieces of network average speed information at which all or part of specific content is received from all the terminals included in the list of terminals, and may transfer the pieces of network average speed information of all the terminals to at least one of the terminals included in the list of terminals. The network speed information transmission/reception unit 10h may be the same as the network speed information transmission/reception unit of the contents server.

The alternative content server function unit 10i may allow the terminal to which the transmission of the specific content has not been completed to directly access the alternative server function unit of the contents server and to receive the specific content, or may directly upload the specific content to the terminal to which the transmission of the specific content has not been completed, if the transmission of the specific content has not been completed by the secondary transmission deadline. The alternative server function unit 10i may be the same as the alternative server function unit of the contents server.

The content distribution log recording unit 10f may receive a reception completion message from the terminal to which the transmission of the specific content has been completed if the transmission of the specific content has been completed, record the received reception completion message and send a reception completion acknowledgement message, indicative that the reception completion message has been received, to the terminal to which the transmission of the specific content has been completed. The content distribution log recording unit 10f may be the same as the DSContDistLog FE of the contents server.

The content distribution plan may further include a transmission deadline by which the transmission of the specific content needs to be completed, and the address of an alternative server function unit of the contents server from which the specific content will be received if the transmission of the specific content has not been completed by the transmission deadline. The transmission deadline may include at least one of the primary transmission deadline and the secondary transmission deadline.

Furthermore, the warning message transmission/reception unit 10g may receive a warning message from a terminal to which the transmission of the specific content has not been completed by the primary transmission deadline. The content distribution peer 10e may receive the held content information of the specific content of a terminal to which the transmission of the specific content has not been completed from the terminal to which the transmission of the specific content has not been completed, and may send all or part of specific content to the terminal to which the transmission of the specific content has not been completed based on the received held content information.

Furthermore, the content distribution plan may further include information about the priority of the specific content. In such a case, the content distribution peer 10e may receive all or part of specific content over another piece of content having priority of “middle” or “low” if the specific content has priority of “high.”

Furthermore, the alternative server function unit 10i may allow at least one of the terminals within the overlay network to directly access the alternative server function unit 10i and to receive the specific content, or may directly upload the specific content to the at least one terminal, if the number of terminals having all or part of specific content is smaller than a predetermined number in the overlay network for the specific content.

The reception completion message may include at least one of a method of receiving the specific content, the reception start time of the specific content, the reception completion time of the specific content, and the network address of a terminal by which the reception of the specific content has been completed.

There are advantages in that the concentration of a load on the contents server can be solved and the idle networks of terminals can be used because digital signage terminals are connected to a network and content is first distributed by the contents server, but pieces of the content are exchanged between other terminals.

Furthermore, content may have been logically fragmented in a predetermined size, and pieces of the content may be exchanged between terminals in the predetermined size. Accordingly, a piece of content can be rapidly received because the content is fragmented and received from multiple terminals at the same time.

In terms of the characteristics of a P2P method, the efficiency of distribution is exponentially increased according to an increase in the number of peers (in this case, DS terminals). P2P-based file sharing is basically a delay-tolerant method. That is, the deadline for the completion of the reception of corresponding content has not been specified. Accordingly, for stable service, a digital signage service provider should be able to check the results of content distribution, and terminals among which content has not been distributed up to a specific time should be able to receive the content prior to the start of service.

The digital signage server (i.e., the contents server) may transfer a content distribution plan to a terminal, and the terminal may receive content according to the content distribution plan and distribute the content to surrounding terminals. A distribution deadline may be specified in the content distribution plan. If corresponding content is not received within the distribution deadline, the ACS directly receives the content, thereby being capable of securing stability.

Conventional P2P file sharing includes a participation/secession process for an overlay network on the client side. In a digital signage environment, however, a participation/secession process for an overlay network is not required because a content distribution server may previously induce a predetermined terminal to participate in the overlay network. Furthermore, all participation node/peers may be terminals managed by service providers. Furthermore, P2P file sharing is based on a terminal-driven method, whereas this method may be a server-driven method.

As described above, the present invention provides an advantage in that a load of a server can be reduced because content is distributed through mutual exchange between terminals using a P2P method.

Furthermore, there is an advantage in that stability can be ensured in the distribution of content although a P2P method is used.

The apparatus and method according to the embodiments of the present invention are not limited and applied to the constructions and methods of the embodiments described as above, but all or some of the embodiments may be selectively combined and configured so that the embodiments may be modified in various ways.

The method of processing bidirectional service related to a broadcasting program according to the present invention may be implemented in a processor-readable recording medium included in a network device in the form of processor-readable code. The processor-readable recording medium includes all kinds of recording devices in which processor-readable data is stored. The processor-readable recording medium may include, for example, ROM, RAM, CD-ROM, magnetic tapes, floppy disks and optical data storages, and may also include a form in which the processor-readable recording medium is implemented in a carrier wave form, such as transmission via the Internet. Furthermore, the processor-readable recording medium may be distributed over computer systems connected over a network, and the processor-readable code may be stored and performed in a distributed manner.

Although the preferred embodiments of the present invention have been disclosed for illustrative purposes, those skilled in the art will appreciate that various modifications, additions and alternatives are possible, without departing from the scope and spirit of the invention as disclosed in the accompanying claims.

What is claimed is:

1. A method by which a terminal receives contents over an overlay network, the method comprising:
receiving notification of a content distribution plan, including information about an ID of specific content, overlay network ID information for the specific content, and an address of a tracker server function unit of a contents server for the overlay network, from the contents server or another terminal within the overlay network;
receiving a list of terminals, included in the overlay network identified by the overlay network ID information, or a list of terminals, managed by the tracker server function unit identified by the address of the tracker server function unit, from the contents server or the other terminal;
receiving held content information, indicating whether or not the specific content is held, from one or more of the terminals within the list; and
receiving the specific content from the one or more terminals based on the held content information.

2. The method of claim 1, further comprising:
sending a reception completion message to the contents server when the specific content is received; and
receiving a reception completion acknowledgement message indicative that the reception completion message has been received from the contents server.

3. The method of claim 2, wherein the reception completion message comprises one or more of a method of receiving the specific content, a reception start time of the specific content, a reception completion time of the specific content, an average transmission speed and average reception speed of the specific content, and information about sharing of the specific content.

4. The method of claim 1, wherein:
the content distribution plan further comprises a transmission deadline by which the reception of the specific content needs to be completed and an address of an alternative server function unit of the contents server from which the specific content is to be received if the reception of the specific content has not been completed by the transmission deadline; and
the transmission deadline comprises one or more of a primary transmission deadline and a secondary transmission deadline.

5. The method of claim 4, further comprising:
sending a warning message to all the terminals within the list and the contents server if the reception of the specific content has not been completed by the primary transmission deadline;
receiving a warning acknowledgement message, indicative that the warning message has been received from a terminal that belongs to all the terminals that have received the warning message and that has the specific content;
receiving held content information of the specific content from one or more of terminals that have sent the warning acknowledgement messages; and
receiving the specific content from the one or more terminals based on the held content information.

6. The method of claim 4, further comprising, if the reception of the specific content has not been completed by the secondary transmission deadline, accessing the alternative server function unit and receiving the specific content, or allowing the alternative server function unit to upload the specific content.

7. The method of claim 1, wherein:
the content distribution plan comprises information about a priority of the specific content; and
receiving the specific content comprises comparing the priority of the specific content with priorities of other pieces of content, and receiving the specific content based on results of the comparison.

8. A method by which a contents server sends contents to a terminal over an overlay network, the method comprising:
configuring, by the contents server, the overlay network for specific content;
setting up a content distribution plan of the specific content over the configured overlay network;
generating a list of terminals, included in the overlay network identified by overlay network ID information included in the content distribution plan, or a list of terminals managed by a tracker server function unit identified by an address of the tracker server function unit of the contents server included in the content distribution plan;
notifying one or more of the terminals within the list of the content distribution;
sending the list of terminal to the one or more of the terminals within the list;
sending held content information, indicating whether or not the specific content is held, to one or more of the terminals within the list; and
sending the specific content to a terminal that has received the held content information.

9. The method of claim 8, further comprising:
receiving a reception completion message from a terminal to which the transmission of the specific content has been completed when the transmission of the specific content is completed;
recording the reception completion message; and
sending a reception completion acknowledgement message, indicative that the reception completion message has been received, to the terminal to which the transmission of the specific content has been completed.

10. The method of claim 8, wherein:
the content distribution plan further comprises a transmission deadline by which the transmission of the specific content needs to be completed, and an address of an alternative server function unit of the contents server from which the specific content is to be received if the transmission of the specific content has not been completed by the transmission deadline; and
the transmission deadline comprises one or more of a primary transmission deadline and a secondary transmission deadline.

11. The method of claim 10, further comprising:
receiving a warning message from a terminal to which the transmission of the specific content has not been completed by the primary transmission deadline;
receiving held content information of the specific content from the terminal to which the transmission of the specific content has not been completed; and
sending the specific content to the terminal to which the transmission of the specific content has not been completed based on the received held content information.

12. The method of claim 10, further comprising, if the transmission of the specific content has not been completed by the secondary transmission deadline, allowing a terminal to which the transmission of the specific content has not been completed to access an alternative server function unit and receive the specific content from the alternative server function unit, or allowing the alternative server function unit to upload the specific content to the terminal to which the transmission of the specific content has not been completed.

13. The method of claim 8, wherein:
the content distribution plan comprises information about a priority of the specific content; and
sending the specific content comprises comparing the priority of the specific content with priorities of other pieces of content, and sending the specific content based on results of the comparison.

14. A digital display terminal, comprising:
a content distribution management unit configured to receive notification of a content distribution plan, including information about an ID of the specific content, overlay network ID information for the specific content, and an address of a tracker server function unit of a contents server for the overlay network from the contents server or another terminal within the overlay network; and
a content distribution peer configured to receive a list of terminals, included in the overlay network identified by the overlay network ID information, or a list of terminals, managed by the tracker server function unit identified by the address of the tracker server function unit, from the contents server or the other terminal, to receive held content information, indicating whether or not the specific content is held, from one or more of the terminals within the list, and to receive the specific content from the one or more terminals based on the held content information.

15. The digital display terminal of claim 14, wherein:
the content distribution plan further comprises a transmission deadline by which the reception of the specific content needs to be completed, and an address of an alternative server function unit of the contents server from which the specific content is to be received if the reception of the specific content has not been completed by the transmission deadline; and
the transmission deadline comprises one or more of a primary transmission deadline and a secondary transmission deadline.

16. The digital display terminal of claim 15, further comprising a warning message transmission/reception unit configured to send a warning message to all the terminals within the list and the contents server if the reception of the specific content has not been completed by the primary transmission deadline, and to receive a warning acknowledgement message, indicative that the warning message has been received from a terminal that belongs to all the terminals that have received the warning message and that has the specific content;
wherein the content distribution peer receives held content information of the specific content from one or more of terminals that have sent the warning acknowledgement messages, and receives the specific content from the one or more terminals based on the held content information.

17. The digital display terminal of claim 15, further comprising, if the reception of the specific content has not been completed by the secondary transmission deadline, a terminal alternative server configured to access an alternative server function unit of the contents server and to receive the specific content, or configured to receive the specific content uploaded by the alternative server function unit.

18. The digital display terminal of claim 17, wherein the terminal alternative server, if a number of terminals having the specific content is smaller than a predetermined number as a result of analysis of the held content information, allows the alternative server function unit of the contents server to be accessed and the specific content to be received from the alternative server function unit or allows the specific content to be uploaded via the alternative server function unit of the contents server.

19. The digital display terminal of claim 14, wherein:
the content distribution plan comprises information about a priority of the specific content; and
the content distribution peer compares the priority of the specific content with priorities of other pieces of content, and receives the specific content based on results of the comparison.

20. The digital display terminal of claim 14, wherein the content distribution peer, when the reception of the specific content is completed, sends a reception completion message to the contents server and receives a reception completion acknowledgement message, indicative that the reception completion message has been received, from the contents server.
